(19) United States
(12) Patent Application Publication
(10) Pub. No.: US 2024/0300538 A1
(43) Pub. Date: Sep. 12, 2024

(54) VEHICLE CONTROL DEVICE, VEHICLE CONTROL METHOD, AND NON-TRANSITORY STORAGE MEDIUM

(71) Applicant: TOYOTA JIDOSHA KABUSHIKI KAISHA, Toyota-shi (JP)

(72) Inventors: Naotoshi KADOTANI, Mishima-shi (JP); Yuki NISHIKAWA, Numazu-shi (JP); Yuki TAKAHASHI, Sunto-gun (JP); Nana KIKUIRE, Sunto-gun (JP); Takahiko KUWABARA, Yokohama-shi (JP); Ryusei GICHU, Tokyo (JP); Takashi OTA, Tokyo (JP); Toshifumi IWASE, Tokyo (JP); Hironori ITO, Tokyo (JP); Hisanobu INOUE, Kawasaki-shi (JP)

(73) Assignee: TOYOTA JIDOSHA KABUSHIKI KAISHA, Toyota-shi (JP)

(21) Appl. No.: 18/593,415

(22) Filed: Mar. 1, 2024

(30) Foreign Application Priority Data
Mar. 6, 2023 (JP) 2023-033847

(51) Int. Cl. B60W 60/00; B60W 30/14; B60W 50/00; B60W 50/14; G01C 21/34

(52) U.S. Cl. CPC B60W 60/00253; B60W 30/146; B60W 50/14; G01C 21/3423; B60W 2050/0083; B60W 2050/146; B60W 2540/215; B60W 2554/406; B60W 2555/60

(57) ABSTRACT

A vehicle control device includes one or more processors configured to: on a travel route of an autonomous driving taxi configured to travel toward a desired drop-off position of a user of the autonomous driving taxi, set a predetermined travel route range from a point behind the desired drop-off position to the desired drop-off position, as a permissible midway drop-off range in which midway drop-off from the autonomous driving taxi is permitted; receive a setting about a midway drop-off position in the permissible midway drop-off range, the setting being made by the user in the autonomous driving taxi configured to travel toward the desired drop-off position; and stop the autonomous driving taxi at the midway drop-off position set by the user such that the user drops off the autonomous driving taxi midway.

### CROSS-REFERENCE TO RELATED APPLICATION

This application claims priority to Japanese Patent Application No. 2023-033847 filed on Mar. 6, 2023, incorporated herein by reference in its entirety.

### BACKGROUND

### 1. Technical Field

The present disclosure relates to a vehicle control device, a vehicle control method, and a non-transitory storage medium.

### 2. Description of Related Art

There is a taxi fare system that, when a taxi user changes a destination during a ride, predicts a taxi fare to the changed destination and presents the predicted taxi fare to the user (see, for example, Japanese Unexamined Patent Application Publication No. 2007-334472 (JP 2007-334472 A)).

### SUMMARY

It is common in manual driving taxis for a taxi user to change a destination during a ride. In autonomous driving taxis, however, there is no technology known to change a destination, that is, a drop-off position during a ride.

A vehicle control device according to a first aspect of the present disclosure includes one or more processors configured to: on a travel route of an autonomous driving taxi configured to travel toward a desired drop-off position of a user of the autonomous driving taxi, set a predetermined travel route range from a point behind the desired drop-off position to the desired drop-off position, as a permissible midway drop-off range in which midway drop-off from the autonomous driving taxi is permitted; receive a setting about a midway drop-off position in the permissible midway drop-off range, the setting being made by the user in the autonomous driving taxi configured to travel toward the desired drop-off position; and stop the autonomous driving taxi at the midway drop-off position set by the user such that the user drops off the autonomous driving taxi midway.

A vehicle control method according to a second aspect of the present disclosure includes: on a travel route of an autonomous driving taxi configured to travel toward a desired drop-off position of a user of the autonomous driving taxi, setting a predetermined travel route range from a point behind the desired drop-off position to the desired drop-off position, as a permissible midway drop-off range in which midway drop-off from the autonomous driving taxi is permitted; receiving a setting about a midway drop-off position in the permissible midway drop-off range, the setting being made by the user in the autonomous driving taxi configured to travel toward the desired drop-off position; and stopping the autonomous driving taxi at the midway drop-off position set by the user such that the user drops off the autonomous driving taxi midway.

A non-transitory storage medium according to a third aspect of the present disclosure stores instructions that are executable by one or more processors and that cause the one or more processors to perform functions. The functions include: on a travel route of an autonomous driving taxi configured to travel toward a desired drop-off position of a user of the autonomous driving taxi, setting a predetermined travel route range from a point behind the desired drop-off position to the desired drop-off position, as a permissible midway drop-off range in which midway drop-off from the autonomous driving taxi is permitted; receiving a setting about a midway drop-off position in the permissible midway drop-off range, the setting being made by the user in the autonomous driving taxi configured to travel toward the desired drop-off position; and stopping the autonomous driving taxi at the midway drop-off position set by the user such that the user drops off the autonomous driving taxi midway.

It is possible to change the drop-off position in the autonomous driving taxi.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an overall diagram of an information processing system;

FIG. 2 is a diagram schematically showing an information processing server shown in FIG. 1;

FIG. 3 is a diagram schematically showing a dispatch management server shown in FIG. 1;

FIG. 4 is a diagram schematically showing an autonomous driving taxi;

FIG. 5 is a functional configuration diagram of the autonomous driving taxi shown in FIG. 4;

FIG. 6 is a diagram showing a flow of information processing in the information processing system;

FIG. 7 is a diagram showing a schematic road map;

FIG. 8 is a diagram illustrating a permissible midway drop-off range X1 and a midway drop-off position settable range X2 on a travel route of the autonomous driving taxi;

FIG. 9 is a diagram showing a road map in which a part of FIG. 7 is enlarged;

FIG. 10 is a diagram showing a vehicle cabin of the autonomous driving taxi;

FIG. 11 is a diagram showing a display screen disposed in the vehicle cabin;

FIG. 12 is a diagram showing the display screen disposed in the vehicle cabin;

FIG. 13 is a diagram showing a schematic road map;

FIG. 14 is a flowchart for a display process;

FIG. 15 is a diagram showing a procedure of a change request 1;

FIG. 16 is a diagram showing a procedure of a change request 2;

FIG. 17 is a flowchart for a drop-off position change request;

FIG. 18 is a diagram showing an input procedure on a terminal;

FIG. 19 is a diagram showing a route selection procedure on the terminal;

FIG. 20 is a flowchart for the information processing;

FIG. 21 is a flowchart for the information processing;

FIG. 22 is a flowchart for dispatch management;

FIG. 23 is a flowchart for driving control on the autonomous driving taxi;

FIG. 24 is a flowchart for the driving control on the autonomous driving taxi;

FIG. 25 is a flowchart for the driving control on the autonomous driving taxi;

FIG. 26 is a flowchart for the display process;

FIG. 27 is a diagram showing a procedure of the change request 1;

FIG. 28 is a diagram showing a procedure of the change request 2;

FIG. 29 is a flowchart for the drop-off position change request;

FIG. 30 is a flowchart for the display process;

FIG. 31 is a diagram showing the display screen disposed in the vehicle cabin;

FIG. 32 is a flowchart for the display process;

FIG. 33 is a flowchart for the display process;

FIG. 34 is a diagram showing the display screen disposed in the vehicle cabin;

FIG. 35 is a flowchart for a display process 1;

FIG. 36 is a flowchart for a display process 2;

FIG. 37 is a diagram showing the display screen disposed in the vehicle cabin;

FIG. 38 is a flowchart for the display process;

FIG. 39 is a flowchart for the display process; and

FIG. 40 is a flowchart for the drop-off position change request.

### DETAILED DESCRIPTION OF EMBODIMENTS

When a person uses an autonomous driving taxi to move to a destination, a plurality of movement routes to the destination is generally present, and one movement route is selected from among these movement routes. In this case, the person may select, as the movement route, a movement route using a plurality of different types of moving body, such as a movement route including transfer from the autonomous driving taxi to a scheduled transportation system. In this case, the destination of the autonomous driving taxi is a location where the passenger of the autonomous driving taxi will drop off for the transfer from the autonomous driving taxi to the scheduled transportation system. For example, when there is traffic congestion near the destination, a walk to the destination may be faster than the movement by the autonomous driving taxi. In this case, the passenger may preferably drop off the autonomous driving taxi midway before arriving at the destination of the autonomous driving taxi. The present disclosure relates to a driving control technology that allows the passenger to drop off the autonomous driving taxi midway before arriving at the destination of the autonomous driving taxi. In this case, a railroad service such as a train, a monorail, a bus, and an airplane correspond to scheduled transportation systems to which the present disclosure is applied. In the following, the present disclosure will be described taking an exemplary case where the scheduled transportation system is a railroad service such as a train. The present disclosure is also applicable to a monorail, a bus, and an airplane other than the railroad service.

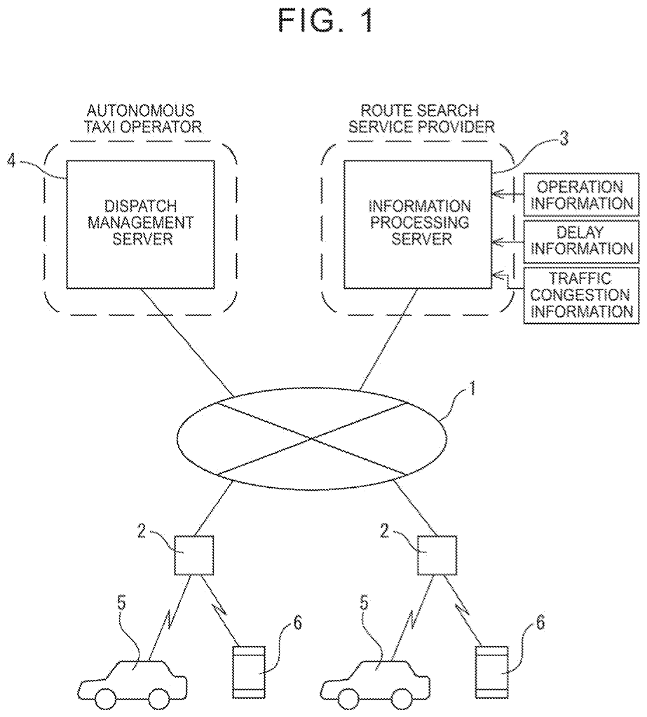

FIG. 1 is an overall diagram of an information processing system suitable for implementing the information processing technology according to the present disclosure. Referring to FIG. 1, reference symbol 1 represents a communication network, reference symbol 2 represents a base station of the communication network 1, reference symbol 3 represents an information processing server managed by a route search service provider, reference symbol 4 represents a dispatch management server that is managed by an autonomous driving taxi operator and provides an autonomous driving taxi dispatch service, reference symbol 5 represents an autonomous driving taxi, and reference symbol 6 represents a terminal owned by a user who uses the dispatch service of the autonomous driving taxi 5. Although the terminal 6 is depicted as a mobile terminal in FIG. 1, the terminal 6 is not limited to the mobile terminal and may be a stationary terminal.

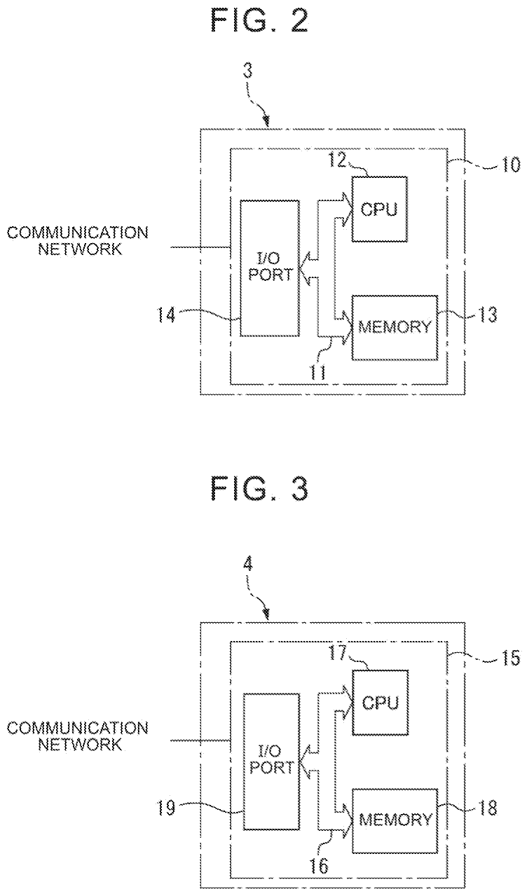

FIG. 2 shows the information processing server 3 shown in FIG. 1. Referring to FIG. 2, an electronic control unit 10 is provided in the information processing server 3. The electronic control unit 10 is a digital computer and includes a central processing unit (CPU) (microprocessor) 12, a memory 13 including a read only memory (ROM) and a random access memory (RAM), and an input/output port 14. These components are connected by a bidirectional bus 11. The electronic control unit 10 is connected to the communication network 1.

FIG. 3 shows the dispatch management server 4 shown in FIG. 1. Referring to FIG. 3, an electronic control unit 15 is provided in the dispatch management server 4. The electronic control unit 15 is a digital computer and includes a CPU (microprocessor) 17, a memory 18 including a ROM and a RAM, and an input/output port 19. These components are connected by a bidirectional bus 16. The electronic control unit 15 is connected to the communication network 1.

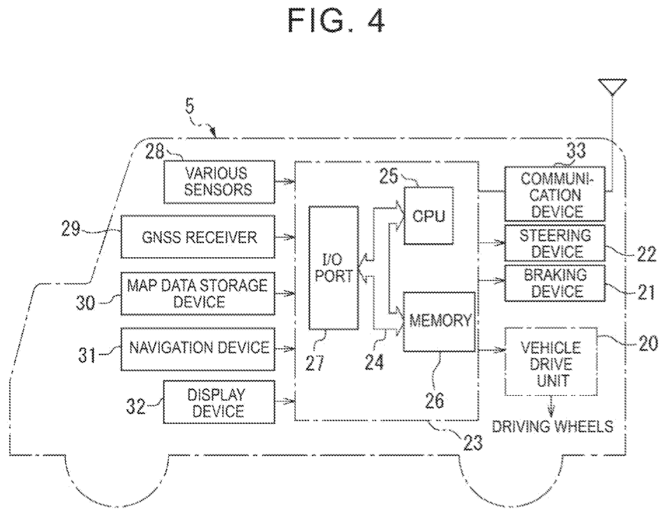

FIG. 4 schematically shows an example of the autonomous driving taxi 5. Referring to FIG. 4, reference symbol 20 represents a vehicle drive unit for applying a driving force to driving wheels of the autonomous driving taxi 5, reference symbol 21 represents a braking device for braking the autonomous driving taxi 5, reference symbol 22 represents a steering device for steering the autonomous driving taxi 5, and reference symbol 23 represents an electronic control unit mounted in the autonomous driving taxi 5. As shown in FIG. 4, the electronic control unit 23 is a digital computer and includes a CPU (microprocessor) 25, a memory 26 including a ROM and a RAM, and an input/output port 27. These components are connected by a bidirectional bus 24. In the example shown in FIG. 4, the vehicle drive unit 20 is an electric motor to be driven by a secondary battery or an electric motor to be driven by a fuel cell, and the drive of the driving wheels is controlled by the electric motor based on an output signal from the electronic control unit 23. The braking of the autonomous driving taxi 5 is controlled by the braking device 21 based on an output signal from the electronic control unit 23, and the steering of the autonomous driving taxi 5 is controlled by the steering device 22 based on an output signal from the electronic control unit 23. The electronic control unit 23 may be constituted by one electronic control unit or by a plurality of electronic control units.

As shown in FIG. 4, the autonomous driving taxi 5 includes various sensors 28 necessary for autonomous driving of the autonomous driving taxi 5, that is, sensors that detect conditions of the autonomous driving taxi 5 and peripheral detection sensors that detect the periphery of the autonomous driving taxi 5. In this case, an acceleration sensor, a speed sensor, and an azimuth angle sensor are used as the sensors that detect the conditions of the autonomous driving taxi 5, and on-board cameras that capture forward, lateral, and rearward images from the autonomous driving taxi 5, a light detection and ranging (LIDAR) sensor, a radar, etc. are used as the peripheral detection sensors that detect the periphery of the autonomous driving taxi 5. The autonomous driving taxi 5 includes a global navigation satellite system (GNSS) receiver 29, a map data storage device 30, a navigation device 31, and a display device 32 including a display screen.

The GNSS receiver 29 can detect a current position (e.g., latitude and longitude) of the autonomous driving taxi 5 based on information acquired from a plurality of satellites. Therefore, the current position of the autonomous driving taxi 5 can be acquired by the GNSS receiver 29. Examples of the GNSS receiver 29 include a global positioning system (GPS) receiver. The map data storage device 30 stores map data etc. necessary for the autonomous driving of the autonomous driving taxi 5. The various sensors 28, the GNSS receiver 29, the map data storage device 30, the navigation device 31, and the display device 32 are connected to the electronic control unit 23. The autonomous driving taxi 5 includes a communication device 33 for communicating with the information processing server 3 and the dispatch management server 4 via the base station 2 and the communication network 1.

The terminal 6 owned by the user who uses the dispatch service can communicate with the information processing server 3, the dispatch management server 4, and the autonomous driving taxi 5 via the base station 2 and the communication network 1. Thus, in the information processing system shown in FIG. 1, the information processing server 3, the dispatch management server 4, the autonomous driving taxi 5, and the terminal 6 can communicate with each other via the communication network 1. In the example shown in FIG. 1, the communication device 33 of the autonomous driving taxi 5 and the terminal 6 each have a short-range wireless communication function. The communication device 33 of the autonomous driving taxi 5 and the terminal 6 can communicate with each other by their short-range wireless communication functions.

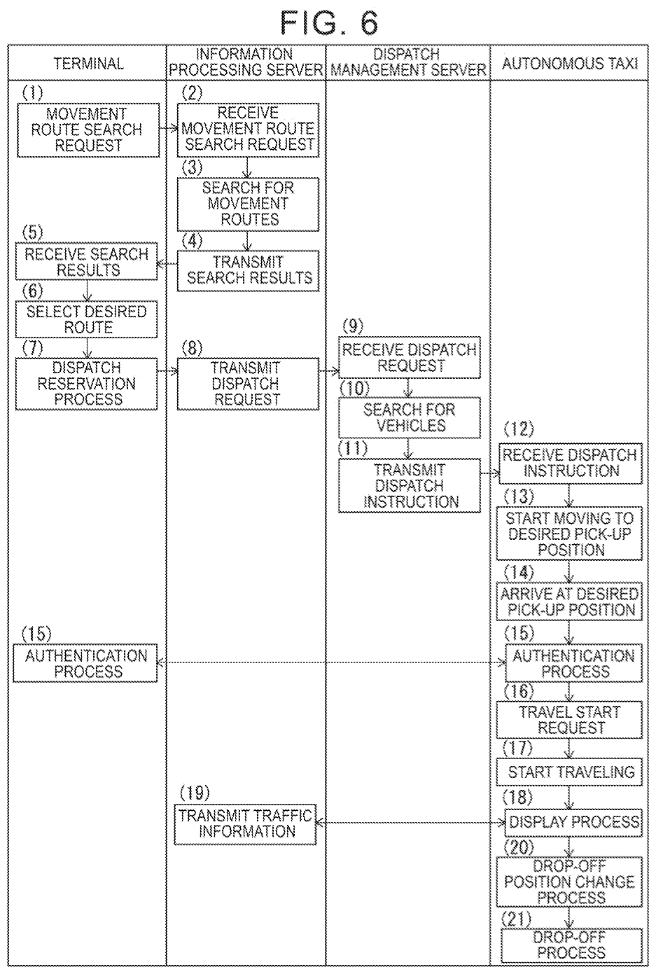

Next, an overall flow of a procedure for determining a movement route and a procedure for dispatching, taking, and dropping off the autonomous driving taxi 5 will be described with reference to FIG. 6. FIG. 6 shows the overall flow of the procedure for determining the movement route and the procedure for dispatching, taking, and dropping off the autonomous driving taxi 5, that is, an overall flow of information processing executed in the embodiment of the present disclosure. FIG. 6 shows exchange among the information processing server 3, the dispatch management server 4, the autonomous driving taxi 5, and the terminal 6. FIG. 6 shows a case where a movement route including transfer to a scheduled train after taking the autonomous driving taxi 5 is selected. Referring to FIG. 6, the user who uses the dispatch service (hereinafter simply referred to as “user”) uses a movement route search application on the terminal 6 in (1) to input a departure point, a departure time, a destination, a desired arrival time at the destination, etc., and make a movement route search request.

In (2), the information processing server 3 receives the movement route search request. In (3), the information processing server 3 searches for a movement route that fulfills the request based on the received departure point, the received departure time, the received destination, the received desired arrival time at the destination, etc. In (4), movement route search results are transmitted from the information processing server 3 to the terminal 6. In (5), the terminal 6 receives the movement route search results. In (6), the user uses the movement route search application on the display screen of the terminal 6 to select a desired movement route from among a plurality of movement routes in the search results.

There may be a case where the movement route search results in (4) do not include a movement route involving transfer from the autonomous driving taxi 5 to a scheduled train. In the information processing flow shown in FIG. 6, description will be given of a case where the movement route search results in (4) include the movement route involving transfer from the autonomous driving taxi 5 to a scheduled train, and the movement route involving transfer from the autonomous driving taxi 5 to a scheduled train is selected as the desired movement route in (6).

When the movement route involving transfer from the autonomous driving taxi 5 to a scheduled train is selected in (6), the user uses a dispatch reservation application on the display screen of the terminal 6 in (7) to register desired dispatch details including a desired pick-up position, a desired pick-up time, and a desired drop-off position for the autonomous driving taxi 5. When the desired dispatch details are registered, information indicating that a dispatch reservation has been made is transmitted from the terminal 6 to the information processing server 3 together with the registered desired dispatch details and the user's desired movement route. When the information processing server 3 receives the information indicating that the dispatch reservation has been made from the terminal 6 together with the desired dispatch details and the user's desired movement route, the received desired dispatch details and the received user's desired movement route are stored in the memory 13 of the information processing server 3. In (8), a dispatch request is transmitted from the information processing server 3 to the dispatch management server 4. The dispatch request includes the user's desired movement route, information on the train expected for transfer on the user's desired movement route, the desired dispatch details including the desired pick-up position, the desired pick-up time, and the desired drop-off position for the autonomous driving taxi 5, and a user identifier (ID) for identifying the user. The dispatch request may include the user's departure point, departure time, destination, and desired arrival time at the destination received by the information processing server 3 in (2).

In (9), the dispatch management server 4 receives the dispatch request. In (10), the dispatch management server 4 searches for autonomous driving taxis 5 that can be dispatched to the user's desired pick-up position at the user's desired pick-up time from among the autonomous driving taxis 5 located near the user's desired pick-up position, and selects an autonomous driving taxi 5 to be dispatched. In this case, the search may be made for currently available autonomous driving taxis 5, and autonomous driving taxis 5 scheduled to become available around the user's desired pick-up time based on reservation information. When the autonomous driving taxi 5 to be dispatched is selected, a dispatch instruction is transmitted from the dispatch management server 4 to the autonomous driving taxi 5 selected for dispatch in (11) together with the user's desired movement route, the information on the train expected for transfer on the user's desired movement route, the desired dispatch details including the pick-up position, the drop-off position, and the pick-up time for the autonomous driving taxi 5, and the user ID.

In (12), the autonomous driving taxi 5 receives the dispatch instruction. Based on the received user's desired pick-up position, the electronic control unit 23 of the autonomous driving taxi 5 generates a travel route from the current position to the user's desired pick-up position. In (13), autonomous driving of the autonomous driving taxi 5 is started, and the autonomous driving taxi 5 travels along the generated travel route to arrive at the user's desired pick-up position at the user's desired pick-up time. In (14), the autonomous driving taxi 5 arrives at the user's desired pick-up position. In (15), a user authentication process is performed by short-range communication between the terminal 6 of the user who has made the dispatch reservation and the autonomous driving taxi 5 when the user gets into the autonomous driving taxi 5. The authentication process is performed, for example, by checking the user ID stored in the memory 26 of the autonomous driving taxi 5 in response to the dispatch request against the user ID stored in the terminal 6 of the user who has made the dispatch request. When the user IDs agree with each other, the user who carries the terminal 6 is authenticated as the user who has made the dispatch request. Various authentication processes such as face authentication are known as user authentication processes. These known authentication processes can be used as the authentication process in (15).

When the user who carries the terminal 6 is authenticated as the user who has made the dispatch request in (15), the door of the autonomous driving taxi 5 is opened and the user or some people and the user get(s) into the autonomous driving taxi 5. When a pick-up check device disposed in the autonomous driving taxi 5 determines that the user or some people and the user has/have got into the taxi, the door of the autonomous driving taxi 5 is closed. In (16), a travel start request for the autonomous driving taxi 5 is made. Based on the user's desired drop-off position, the electronic control unit 23 of the autonomous driving taxi 5 generates a travel route from the current position to the user's desired drop-off position. In (17), autonomous driving of the autonomous driving taxi 5 is started, and the autonomous driving taxi 5 travels along the generated travel route toward the user's desired drop-off position.

When the autonomous driving taxi 5 travels toward the user's desired drop-off position, a display process is performed in (18) to display a traffic condition such as traffic congestion on the travel route of the autonomous driving taxi 5 on a display screen disposed in a vehicle cabin of the autonomous driving taxi 5. This traffic information such as traffic congestion is transmitted from the information processing server 3 to the autonomous driving taxi 5 in (19) in response to a request from the autonomous driving taxi 5. For example, when a walk to the user's desired drop-off position is faster than the movement by the autonomous driving taxi 5 based on the traffic condition, a drop-off position change process is performed in (20) to change the drop-off position of the autonomous driving taxi 5 so that the user will drop off the autonomous driving taxi 5 midway. In (21), a drop-off process is performed so that the user etc. drops off the autonomous driving taxi 5 midway. The display process in (18), the traffic information transmission process in (19), the drop-off position change process in (20), and the drop-off process in (21) will be described in detail later.

Next, the configurations of the information processing server 3, the dispatch management server 4, the autonomous driving taxi 5, and the terminal 6 for execution of the flow of the information processing shown in FIG. 6 will be described sequentially. First, the configuration of the information processing server 3 will be described. The information processing server 3 can communicate with the dispatch management server 4, the autonomous driving taxi 5, and the terminal 6 via the communication network 1. The information processing server 3 includes an information receiving unit configured to receive, via the communication network 1, railroad operation information and railroad delay information in real time from a railroad operator and road traffic congestion information in real time from a municipality etc. The information processing server 3 includes a search request receiving unit that receives a movement route search request from the user's terminal 6 together with a departure point, a departure time, a destination, a desired arrival time at the destination, etc. The information processing server 3 includes a movement route search unit configured to search for a plurality of movement routes including a multimodal movement route using at least the autonomous driving taxi 5 and a train based on the departure point, the departure time, the destination, the desired arrival time at the destination, etc. received by the search request receiving unit.

The information processing server 3 includes a search result transmitting unit for transmitting, to the user's terminal 6, the movement routes in the search results obtained by the movement route search unit. The information processing server 3 includes a dispatch reservation receiving unit that receives, from the user's terminal 6, desired dispatch details including a desired pick-up position, a desired pick-up time, and a desired drop-off position for the autonomous driving taxi 5 and information indicating that a dispatch reservation has been made together with a user's desired movement route. The information processing server 3 acquires the user's desired movement route, the desired dispatch details including the pick-up position, the drop-off position, and the pick-up time for the autonomous driving taxi 5 to be used by the user on the user's desired movement route, and information on a train expected for transfer on the user's desired movement route. The information processing server 3 includes a dispatch request transmitting unit that transmits, to the dispatch management server 4, a dispatch request including the acquired user's desired movement route, the acquired desired dispatch details, and the acquired information on the train. The information processing server 3 includes an information providing unit that provides the user with various types of information other than the movement routes in the search results.

Next, the configuration of the dispatch management server 4 will be described. The dispatch management server 4 can communicate with the information processing server 3, the autonomous driving taxi 5, and the terminal 6 via the communication network 1. The dispatch management server 4 includes a dispatch request receiving unit for receiving, from the information processing server 3, the user's desired movement route, the desired dispatch details including the pick-up position, the drop-off position, and the pick-up time for the autonomous driving taxi 5 to be used by the user, and the information on the train expected for transfer. The dispatch management server 4 includes a vehicle search unit that searches for autonomous driving taxis 5 that can be dispatched to the user's desired pick-up position at the user's desired pick-up time from among the autonomous driving taxis 5 located near the user's desired pick-up position, and selects an autonomous driving taxi 5 to be dispatched. The dispatch management server 4 includes a dispatch instruction transmitting unit for transmitting, to the autonomous driving taxi 5 selected for dispatch, a dispatch instruction together with the user's desired movement route, the desired dispatch details including the pick-up position, the drop-off position, and the pick-up time for the autonomous driving taxi 5 to be used by the user, and the information on the train expected for transfer.

Next, the configuration of the terminal 6 will be described. The terminal 6 includes a communication unit for communicating with the information processing server 3, the dispatch management server 4, and the autonomous driving taxi 5 via the communication network 1. The terminal 6 includes a current position acquiring unit such as a GPS receiver that can detect a current position (e.g., latitude and longitude) of the terminal 6. The terminal 6 includes a display screen. The terminal 6 uses the movement route search application on the display screen of the terminal 6 to input a departure point, a departure time, a destination, a desired arrival time at the destination, etc., and make a movement route search request. The terminal 6 can display a plurality of movement routes in the search results obtained by the information processing server 3 on the display screen of the terminal 6. On the display screen of the terminal 6, the terminal 6 can select a movement route desired by the user from among the movement routes in the search results obtained by the information processing server 3, and make a dispatch reservation for the autonomous driving taxi 5. In this case, the dispatch reservation application may be used on the display screen of the terminal 6 to make a dispatch reservation directly to the dispatch management server 4.

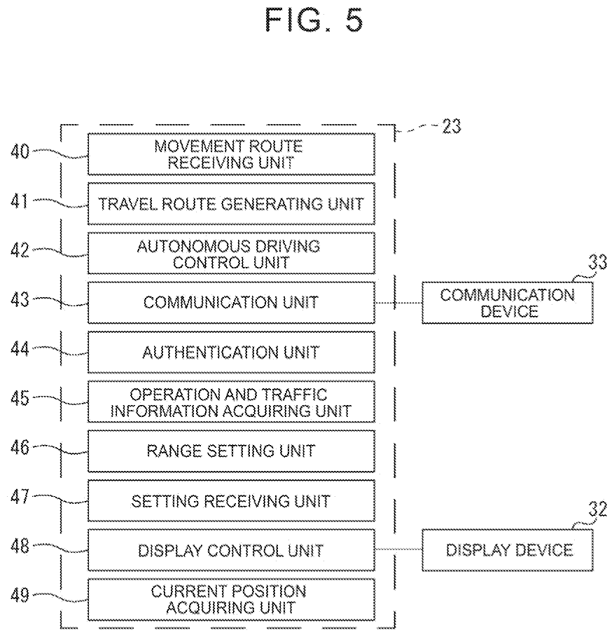

Finally, the configuration of the autonomous driving taxi 5 will be described. Since the overall configuration of the autonomous driving taxi 5 has already been described with reference to FIG. 4, various types of control to be performed by the electronic control unit 23 of the autonomous driving taxi 5 will be described with reference to a functional configuration diagram of FIG. 5. Referring to FIG. 5, the autonomous driving taxi 5 includes a movement route receiving unit 40, a travel route generating unit 41, an autonomous driving control unit 42, a communication unit 43, an authentication unit 44, an operation and traffic information acquiring unit 45, a range setting unit 46, a setting receiving unit 47, a display control unit 48, and a current position acquiring unit 49. A vehicle control device according to one embodiment of the present disclosure is constituted by the movement route receiving unit 40, the communication unit 43, the range setting unit 46, the setting receiving unit 47, and the display control unit 48.

In FIG. 5, the movement route receiving unit 40 receives, from the dispatch management server 4, the user's desired movement route, the desired dispatch details including the pick-up position, the drop-off position, and the pick-up time for the autonomous driving taxi 5 to be used by the user, and the information on the train expected for transfer. In this case, the movement route receiving unit 40 may receive these pieces of information etc. from the information processing server 3. Based on these pieces of information, the travel route generating unit 41 generates a travel route of the autonomous driving taxi 5 from the current position to the user's desired pick-up position, and a travel route of the autonomous driving taxi 5 from the user's desired pick-up position to the user's desired drop-off position.

The autonomous driving control unit 42 controls the autonomous driving of the autonomous driving taxi 5 along the generated travel route. The communication unit 43 is connected to the communication device 33 and can communicate with the information processing server 3, the dispatch management server 4, and the terminal 6 via the communication device 33. The authentication unit 44 authenticates a person getting into the autonomous driving taxi 5 as the user who has made the dispatch reservation for the autonomous driving taxi 5. The operation and traffic information acquiring unit 45 acquires railroad operation information and road traffic congestion information from the information processing server 3. The range setting unit 46 and the setting receiving unit 47 will be described later. The display control unit 48 is connected to the display device 32 including the display screen disposed in the autonomous driving taxi 5, and controls display contents of the display screen disposed in the autonomous driving taxi 5. The current position acquiring unit 49 acquires the current position of the autonomous driving taxi 5 based on reception data received by the GNSS receiver 29.

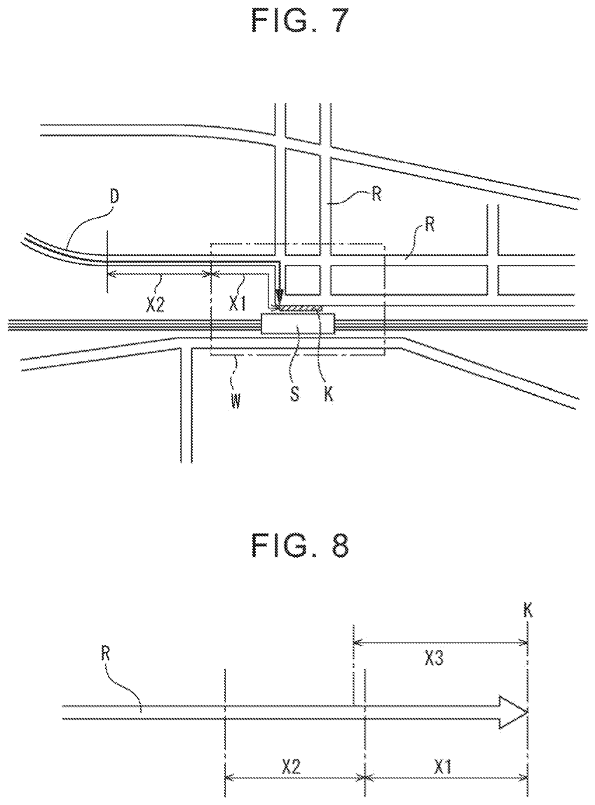

For example, when there is traffic congestion near the user's desired drop-off position as described above, the drop-off from the autonomous driving taxi 5 and the walk to the user's desired drop-off position may be faster than the movement by the autonomous driving taxi 5. In this case, the user may preferably drop off the autonomous driving taxi midway before the autonomous driving taxi 5 arrives at the user's desired drop-off position. This will be described with reference to one specific example shown in FIG. 7.

In a road map shown in FIG. 7, reference symbol S represents a railroad station, reference symbol R represents a road, and reference symbol K represents a vehicle pick-up and drop-off area near the station S. In the specific example shown in FIG. 7, the vehicle pick-up and drop-off area K is the user's desired drop-off position. In FIG. 7, a travel route of the autonomous driving taxi 5 to the vehicle pick-up and drop-off area K is represented by a wide line D.

In the embodiment of the present disclosure, as shown in FIG. 7, a predetermined travel route range X1 from a point behind the user's desired drop-off position K to the desired drop-off position K on the travel route D of the autonomous driving taxi 5 headed for the desired drop-off position K is set as a permissible midway drop-off range in which midway drop-off from the autonomous driving taxi 5 is permitted. The passenger such as the user in the autonomous driving taxi 5 can drop off the autonomous driving taxi 5 midway only in the permissible midway drop-off range X1. For example, the permissible midway drop-off range X1 is a range in which, when there is traffic congestion near the desired drop-off position K, the midway drop-off in the permissible midway drop-off range X1 and the walk to the desired drop-off position K are faster than the movement by the autonomous driving taxi 5. The permissible midway drop-off range X1 includes a range in which, even when there is no traffic congestion near the desired drop-off position K, the midway drop-off in the permissible midway drop-off range X1 and the walk to the desired drop-off position K are faster than the movement by the autonomous driving taxi 5.

The permissible midway drop-off range X1 can be defined by a distance from the point behind the desired drop-off position K to the desired drop-off position K, or by a period required to arrive at the desired drop-off position K from the point behind the desired drop-off position K. The permissible midway drop-off range X1 can be a fixed range in which the midway drop-off in the permissible midway drop-off range X1 and the walk to the desired drop-off position K are predicted to be faster than the movement by the autonomous driving taxi 5 in many cases based on past experience or past statistics, or a fixed range in which even an elderly person can walk without reluctance based on past experience or past statistics. For example, the permissible midway drop-off range X1 can be set to 500 m. That is, the permissible midway drop-off range X1 can be a travel route range in which it is recommended to walk than to use the autonomous driving taxi 5.

When the traffic congestion on the travel route D of the autonomous driving taxi 5 is heavy, the moving speed of the autonomous driving taxi 5 decreases. Therefore, the range of the travel route D in which the walk is faster than the movement by the autonomous driving taxi 5 increases. Therefore, in the embodiment of the present disclosure, the permissible midway drop-off range X1 increases as the traffic congestion is heavier. In this way, in the embodiment of the present disclosure, the permissible midway drop-off range X1 is set to change depending on the traffic condition.

In the embodiment of the present disclosure, as shown in FIG. 7, a predetermined travel route range from a point behind the permissible midway drop-off range X1 to the permissible midway drop-off range X1 is set as a midway drop-off position settable range X2 in which the setting of the midway drop-off position in the permissible midway drop-off range X1 is received in advance. The passenger such as the user in the autonomous driving taxi 5, that is, the user of the autonomous driving taxi 5 can set the midway drop-off position in the permissible midway drop-off range X1 within the midway drop-off position settable range X2. Also within the permissible midway drop-off range X1, the passenger such as the user in the autonomous driving taxi 5 can set the midway drop-off position in the permissible midway drop-off range X1. Therefore, the passenger such as the user in the autonomous driving taxi 5, that is, the user of the autonomous driving taxi 5 can set, within the permissible midway drop-off range X1 and the midway drop-off position settable range X2, the midway drop-off position in the permissible midway drop-off range X1, and cannot set, outside the permissible midway drop-off range X1 and the midway drop-off position settable range X2, the midway drop-off position in the permissible midway drop-off range X1.

The midway drop-off position settable range X2 is a range in which, when the midway drop-off position in the permissible midway drop-off range X1 is set within the midway drop-off position settable range X2 and then the autonomous driving taxi 5 advances to the permissible midway drop-off range X1, the traffic condition in the permissible midway drop-off range X1 does not greatly change between the timing when the midway drop-off position is set and the timing when the autonomous driving taxi 5 advances to the permissible midway drop-off range X1. That is, if the midway drop-off position settable range X2 is set excessively wide, the traffic condition in the permissible midway drop-off range X1 may greatly change between the timing when the midway drop-off position is set and the timing when the autonomous driving taxi advances to the permissible midway drop-off range X1. Therefore, whether the walk is faster than the movement by the autonomous driving taxi 5 cannot be determined even when the passenger drops off at the set midway drop-off position. Thus, the midway drop-off position settable range X2 cannot be set excessively wide.

The midway drop-off position settable range X2 can be defined by a distance from the point behind the permissible midway drop-off range X1 to the permissible midway drop-off range X1, or by a period required to arrive at the permissible midway drop-off range X1 from the point behind the permissible midway drop-off range X1. In this case, the midway drop-off position settable range X2 may be a fixed range based on past experience or past statistics similarly to the permissible midway drop-off range X1. For example, the midway drop-off position settable range X2 can be set to 500 m.

FIG. 8 shows a relationship among the desired drop-off position K, the permissible midway drop-off range X1, and the midway drop-off position settable range X2 on the travel route D of the autonomous driving taxi 5. In FIG. 8, reference symbol X3 represents a travel route range in which the autonomous driving taxi 5 travels at a vehicle speed lower than the vehicle speed during normal driving on the travel route before arrival at the midway drop-off position settable range X2 in order to stop the autonomous driving taxi 5. As shown in FIG. 8, the travel route range X3 is a range from a point slightly behind the permissible midway drop-off range X1 to the desired drop-off position K. In the embodiment of the present disclosure, the autonomous driving taxi 5 in at least the permissible midway drop-off range X1 performs autonomous driving at a vehicle speed lower than the vehicle speed during normal driving on the travel route before arrival at the midway drop-off position settable range X2.

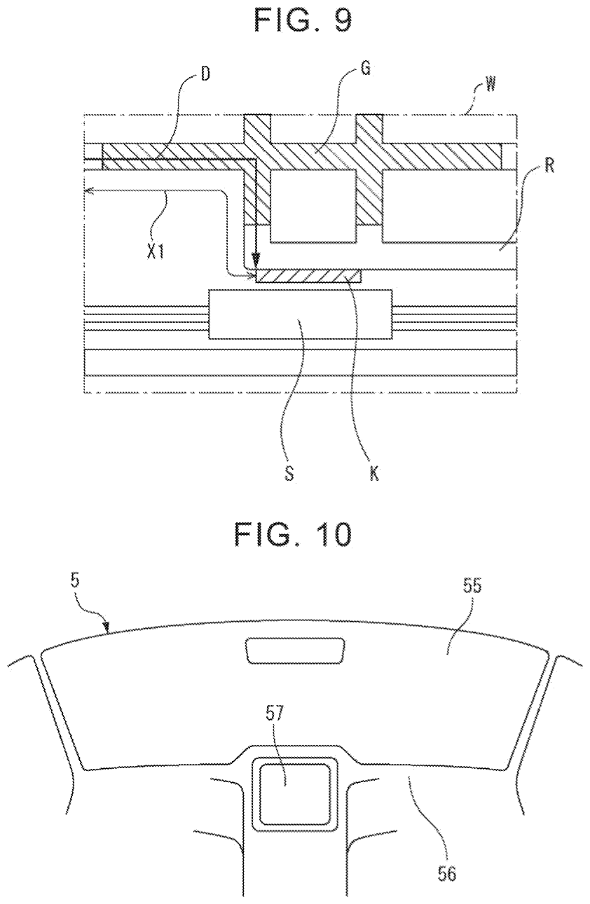

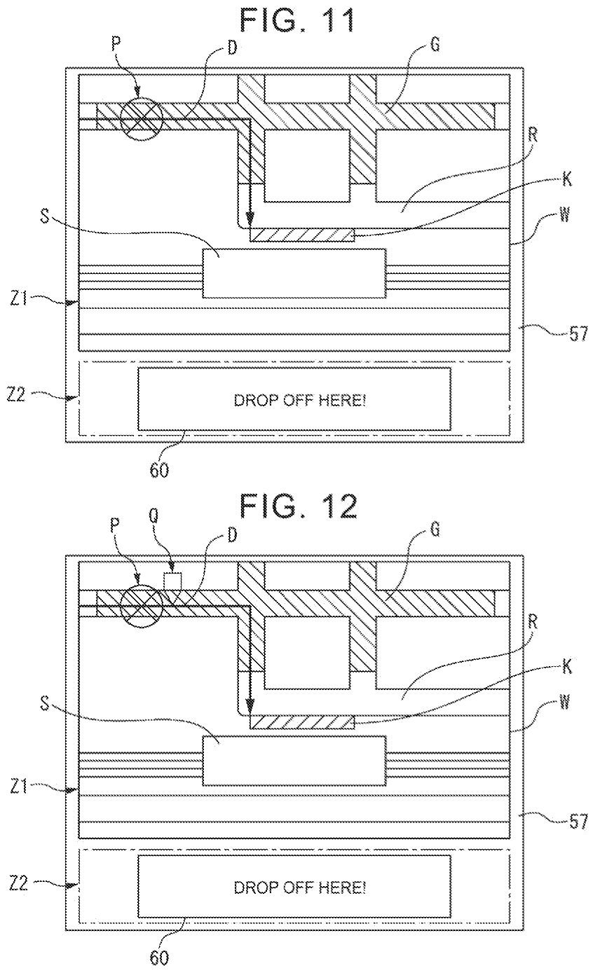

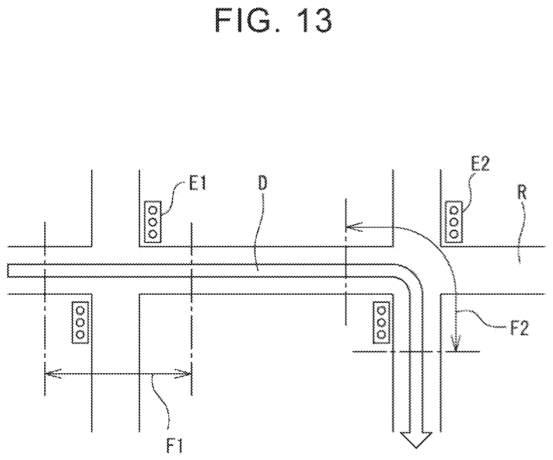

In FIG. 7, a road map area enclosed by a chain line W is adjusted to show the desired drop-off position K at the center and include the entire permissible midway drop-off range X1 alone on the travel route D of the autonomous driving taxi 5. FIG. 9 is an enlarged view of the road map area W. FIG. 10 shows the vehicle cabin of the autonomous driving taxi 5. In FIG. 10, reference symbol 55 represents a windshield, reference symbol 56 represents a dashboard at the front of the vehicle cabin, and reference symbol 57 represents the display screen of the display device 32 disposed in the vehicle cabin. FIGS. 11 and 12 show examples of display contents displayed on the display screen 57 of the display device 32.

Referring to FIGS. 11 and 12, a screen area Z1 where the road map area W shown in FIG. 9 is displayed and a setting operation screen area Z2 where an operation button etc. are displayed are set on the display screen 57. In the examples shown in FIGS. 11 and 12, one operation button 60 is displayed in the setting operation screen area Z2. In the examples shown in FIGS. 7, 9, 11, and 12, the map area adjusted to show the desired drop-off position K at the center and include the entire permissible midway drop-off range X1 alone on the travel route D of the autonomous driving taxi 5 is the road map area W displayed on the display screen 57 of the display device 32. The road map may be displayed on the display screen 57 with the traveling direction of the autonomous driving taxi 5 being the vertical direction of the display screen 57. The road map may be displayed on the display screen 57 to include the midway drop-off position settable range X2 in addition to the permissible midway drop-off range X1 or to include the midway drop-off position settable range X2 and the travel route D before arrival at the midway drop-off position settable range X2 in addition to the permissible midway drop-off range X1.

As described above, there are various ways of displaying the road map on the display screen 57. The following examples will be described taking the exemplary case where the map area adjusted to show the desired drop-off position K at the center and include the entire permissible midway drop-off range X1 alone on the travel route D of the autonomous driving taxi 5 is the road map area W displayed on the display screen 57 of the display device 32 as shown in FIGS. 7, 9, 11, and 12. In FIGS. 9, 11, and 12, the hatched area on the road R is a traffic congestion area G. In FIGS. 11 and 12 showing the display screen 57 disposed in the vehicle cabin, a symbol P displayed on the road R represents a current position of the autonomous driving taxi 5.

In the example shown in FIG. 11, the autonomous driving taxi 5 is traveling along the travel route D in the traffic congestion area G within the permissible midway drop-off range X1. When the current position of the autonomous driving taxi 5 is the position P and the passenger touches the operation button 60 on the display screen 57, the autonomous driving taxi 5 is stopped at the current position P. In the example shown in FIG. 12, the autonomous driving taxi 5 is traveling along the travel route D in the traffic congestion area G within the permissible midway drop-off range X1. At this time, a drop-off position candidate desired by the passenger is displayed ahead of the current position P in the traveling direction on the travel route D. A symbol Q shown in FIG. 12 represents the drop-off position candidate desired by the passenger. For example, when a fingertip touches the travel route D ahead of the current position P in the traveling direction on the display screen 57, the symbol Q representing the drop-off position candidate is displayed at the point touched by the fingertip.

When the passenger touches the operation button 60 on the display screen 57 with the symbol Q displayed, the point where the symbol Q is displayed is set as a midway drop-off position. When the midway drop-off position is set in this way and the autonomous driving taxi 5 arrives at the midway drop-off position, the autonomous driving taxi 5 is stopped. As described above, the midway drop-off position can be set also when the autonomous driving taxi 5 is traveling within the midway drop-off position settable range X2. The drop-off position candidate represented by the symbol Q will hereinafter be referred to as “drop-off position candidate Q” and sometimes as “midway drop-off position Q”.

Thus, in the embodiment of the present disclosure, the autonomous driving taxi 5 can be stopped in order to allow the passenger to drop off the autonomous driving taxi 5 midway. When traffic lights E1, E2 in the traveling direction of the autonomous driving taxi 5 are green at intersections on the congested travel route D of the autonomous driving taxi 5 as shown in FIG. 13 and the autonomous driving taxi 5 is stopped near each intersection, the autonomous driving taxi 5 may hinder the traffic. In the embodiment of the present disclosure, when the traffic lights E1, E2 in the traveling direction of the autonomous driving taxi are green at the intersections on the congested travel route D of the autonomous driving taxi 5, the midway drop-off from the autonomous driving taxi 5 on the travel route D within predetermined ranges F1, F2 from the intersections is prohibited as shown in FIG. 13 though the autonomous driving taxi 5 is in the permissible midway drop-off range X1.

For example, in FIG. 11, when the current position P is an intersection, the passenger touches the operation button 60 on the display screen 57, and the traffic lights in the traveling direction of the autonomous driving taxi 5 are green, the autonomous driving taxi 5 is stopped in response to movement of the autonomous driving taxi 5 by a predetermined distance from the intersection. In FIG. 12, when the set midway drop-off position Q is an intersection and the traffic lights in the traveling direction of the autonomous driving taxi 5 are green, the autonomous driving taxi 5 is stopped in response to arrival of the autonomous driving taxi 5 at a point behind the intersection by a predetermined distance or movement of the autonomous driving taxi 5 by a predetermined distance from the intersection.

Description will be given again about (18) to (20) in the flow of FIG. 6. In the embodiment of the present disclosure, after the dispatched autonomous driving taxi 5 has started traveling toward the user's desired drop-off position, the display process is performed in (18) in the flow of FIG. 6 to display the map screen and the setting operation screen shown in FIG. 11 on the display screen 57 disposed in the vehicle cabin of the autonomous driving taxi 5, and display the traffic congestion area G on the map screen. In this case, the traffic information such as traffic congestion is transmitted from the information processing server 3 to the autonomous driving taxi 5 in (19) in response to a request from the autonomous driving taxi 5. For example, when a walk to the user's desired drop-off position is faster than the movement by the autonomous driving taxi 5 based on the traffic condition after the map screen and the setting operation screen have been displayed on the display screen 57, the drop-off position change process is performed in (20) to change the drop-off position of the autonomous driving taxi 5 so that the user will drop off the autonomous driving taxi 5 midway.

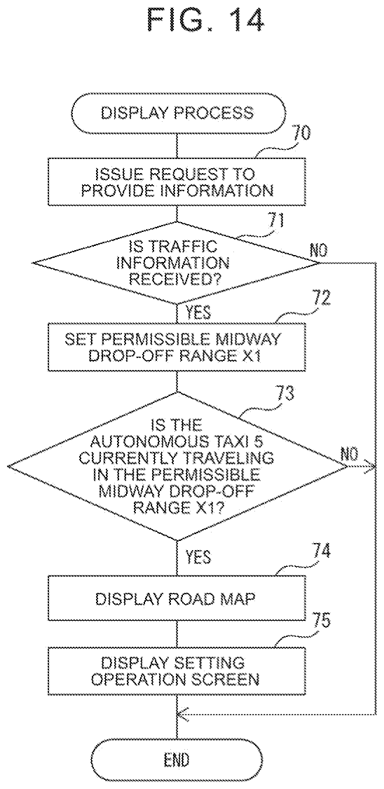

Next, a first embodiment of the present disclosure will be described with reference to FIGS. 14 to 17.

FIG. 14 shows a display process routine for executing the display process in (18) in the flow of FIG. 6. This display process routine is executed by interruption at predetermined time intervals in the electronic control unit 23 of the autonomous driving taxi 5 selected for dispatch.
Referring to FIG. 14, a request to provide traffic information such as traffic congestion is first issued to the information processing server 3 in step 70. In step 71, determination is made as to whether the traffic information such as traffic congestion is received from the information processing server 3 in response to the request. When determination is made that the traffic information such as traffic congestion is not received, the processing cycle is terminated. When determination is made that the traffic information such as traffic congestion is received, the routine proceeds to step 72.

In step 72, a permissible midway drop-off range X1 is set depending on the intensity of traffic congestion. In this case, the permissible midway drop-off range X1 increases as the traffic congestion is heavier as described above. In step 73, determination is made as to whether the autonomous driving taxi 5 is currently traveling in the permissible midway drop-off range X1. When determination is made that the autonomous driving taxi 5 is not traveling in the permissible midway drop-off range X1, the processing cycle is terminated. When determination is made that the autonomous driving taxi 5 is traveling in the permissible midway drop-off range X1, the routine proceeds to step 74. In step 74, a road map as shown in FIG. 11 is displayed on the display screen 57 disposed in the vehicle cabin. In step 75, an operation button 60 as shown in FIG. 11 is displayed on the display screen 57 disposed in the vehicle cabin. Then, the processing cycle is terminated. As described above, in the first embodiment, when the autonomous driving taxi 5 starts traveling in the permissible midway drop-off range X1, the road map and the operation button 60 are displayed on the display screen 57 disposed in the vehicle cabin.

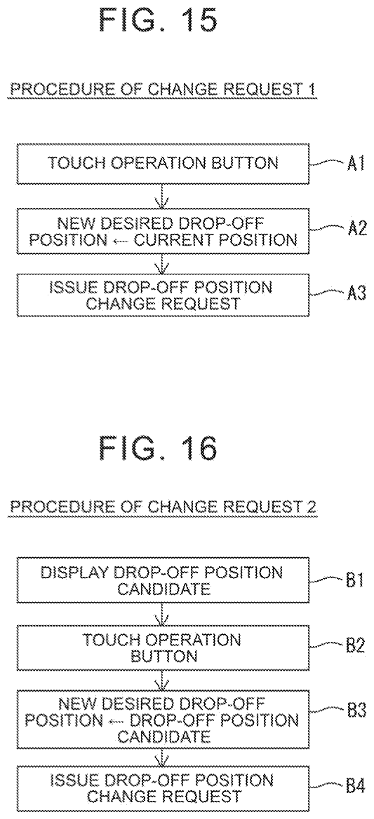

In each embodiment to be described below as well as the first embodiment, when a drop-off position change request is issued to request a change in the drop-off position of the autonomous driving taxi 5, the drop-off position of the autonomous driving taxi 5 is changed from the desired drop-off position at the time of the dispatch reservation made by the user to a midway drop-off position. FIGS. 15 and 16 show a procedure for issuing the drop-off position change request on the display screen 57 disposed in the vehicle cabin in the first embodiment. As described above, in the first embodiment, when the autonomous driving taxi 5 starts traveling in the permissible midway drop-off range X1, the road map and the operation button 60 as shown in FIG. 11 are displayed on the display screen 57 disposed in the vehicle cabin.

The procedure of a change request 1 shown in FIG. 15 is a procedure for issuing, when the current position of the autonomous driving taxi 5 is the position P as shown in FIG. 11, a drop-off position change request to set the current position P as a new desired drop-off position. Referring to FIG. 15, when the passenger wants to drop off at the current position P, the passenger first touches the operation button 60 on the display screen 57 in A1. When the passenger touches the operation button 60, the current position P is set to a new desired drop-off position in A2. In A3, a drop-off position change request is issued.

The procedure of a change request 2 shown in FIG. 16 is a procedure for issuing, when the passenger displays a drop-off position candidate Q where the passenger wants to drop off on the travel route D ahead of the current position P in the traveling direction as shown in FIG. 12, a drop-off position change request to set the drop-off position candidate Q as a new desired drop-off position. Referring to FIG. 16, when the passenger wants to drop off at the drop-off position candidate Q, the passenger first touches, for example, the travel route D ahead of the current position P in the traveling direction on the display screen 57 with his/her fingertip to display the drop-off position candidate Q at the point touched by the fingertip in B1. In B2, the passenger touches the operation button 60 on the display screen 57. When the passenger touches the operation button 60, the drop-off position candidate Q is set to a new desired drop-off position in B3. In B4, a drop-off position change request is issued.

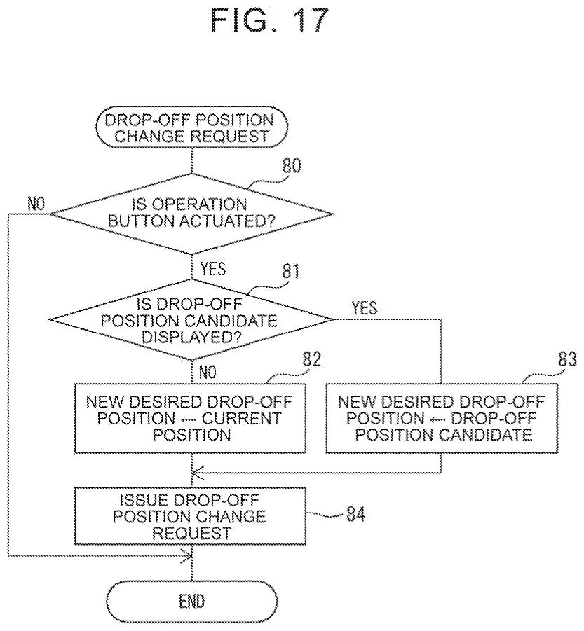

FIG. 17 shows a drop-off position change request routine for executing the procedure of the change request 1 shown in FIG. 15 and the procedure of the change request 2 shown in FIG. 16. This drop-off position change request routine shown in FIG. 17 is executed by interruption at predetermined time intervals in the electronic control unit 23 of the autonomous driving taxi 5. Referring to FIG. 17, determination is first made in step 80 as to whether the operation button 60 is actuated, for example, whether the operation button 60 is touched. When determination is made that the operation button 60 is not actuated, the processing cycle is terminated. When determination is made that the operation button 60 is actuated, the routine proceeds to step 81. Determination is made as to whether the drop-off position candidate Q is displayed on the display screen 57 disposed in the vehicle cabin.

When determination is made that the drop-off position candidate Q is not displayed on the display screen 57, the routine proceeds to step 82. The current position is set as a new desired drop-off position. Next, the routine proceeds to step 84, and a drop-off position change request is issued. Then, the processing cycle is terminated. When determination is made in step 81 that the drop-off position candidate Q is displayed on the display screen 57, the routine proceeds to step 83. The drop-off position candidate Q is set as a new desired drop-off position. Next, the routine proceeds to step 84, and a drop-off position change request is issued.

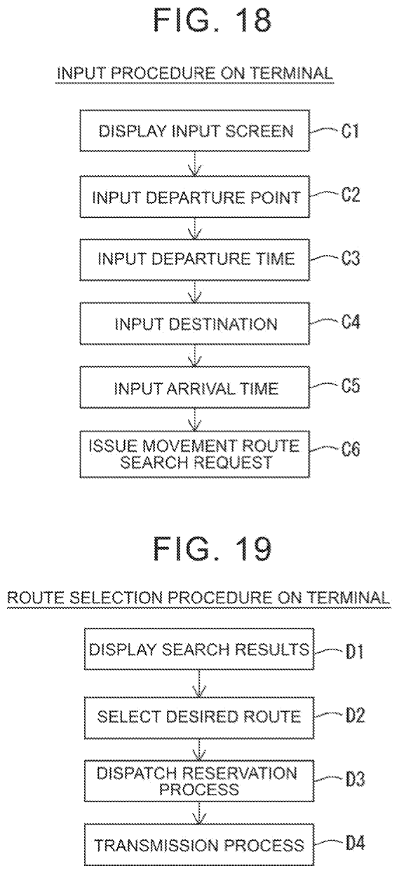

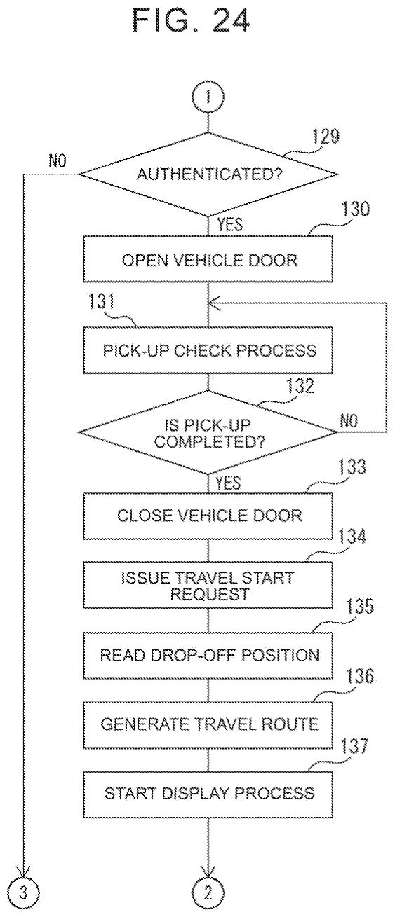

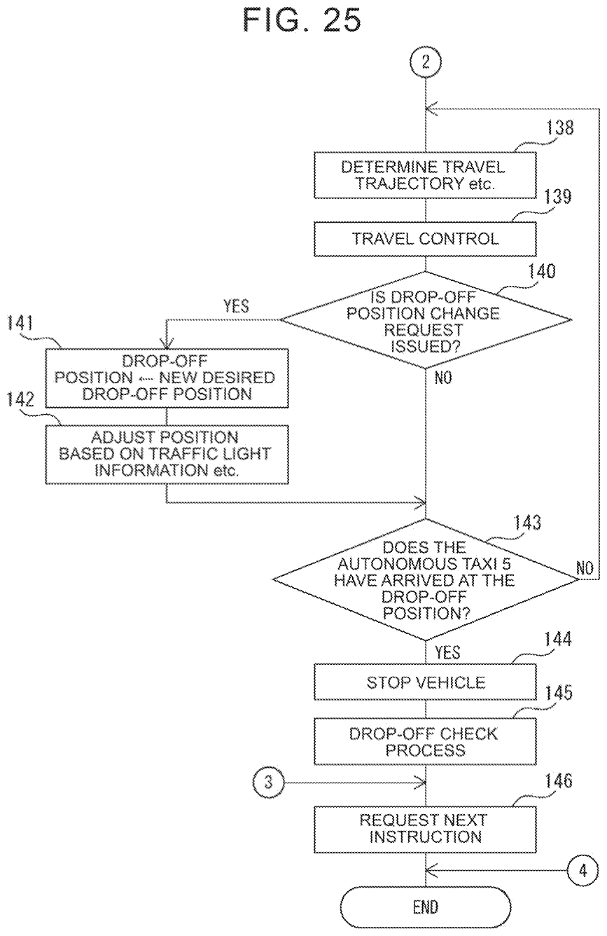

Next, an example of a procedure for executing the process from (1) to (21) in the overall flow of FIG. 6 and the various routines will be described with reference to FIGS. 18 to 25. The procedure and various routines to be described below are used in common in both the first embodiment already described above and each embodiment to be described below.

FIG. 18 shows an input procedure performed on the terminal 6 by the user in (1) of FIG. 6. Referring to FIG. 18, a movement route search input screen is first displayed on the display screen of the terminal 6 in C1 by using the movement route search application. In C2, a departure point is entered in, for example, a departure point entry field of the input screen. In this case, the departure point may be specified on a map displayed on the display screen of the terminal 6. In C3, a departure time is entered in a departure time entry field of the input screen. In C4, a destination is entered in, for example, a destination entry field of the input screen. In this case as well, the destination may be specified on the map displayed on the display screen of the terminal 6. In C5, a desired arrival time at the destination is entered in a desired arrival time entry field of the input screen. In C6, for example, a search request button displayed on the input screen is touched. When the search request button is touched, a movement route search request is transmitted to the information processing server 3 together with the input departure point, the input departure time, the input destination, and the input desired arrival time at the destination.

FIG. 19 shows a route selection procedure performed on the terminal 6 by the user in (5) to (7) of FIG. 6. Referring to FIG. 19, search results showing a plurality of movement routes transmitted from the information processing server 3 are first displayed on the display screen of the terminal 6 in D1. In D2, a desired movement route is selected from among these movement routes. Description will be given of a case where a movement route involving transfer from the autonomous driving taxi 5 to a scheduled train is selected as the desired movement route. When the desired movement route is selected in D2, the user uses the dispatch reservation application on the display screen of the terminal 6 in D3 to register desired dispatch details including a desired pick-up position, a desired pick-up time, and a desired drop-off position for the autonomous driving taxi 5 in entry fields for the desired pick-up position, the desired pick-up time, and the desired drop-off position. In this case as well, the desired pick-up position and the desired drop-off position may be registered by specifying the desired pick-up position and the desired drop-off position on the map displayed on the display screen of the terminal 6. When the desired dispatch details including the desired pick-up position, the desired pick-up time, and the desired drop-off position are registered, information indicating that a dispatch reservation has been made is transmitted from the terminal 6 to the information processing server 3 in D4 together with the registered desired dispatch details and the user's desired movement route.

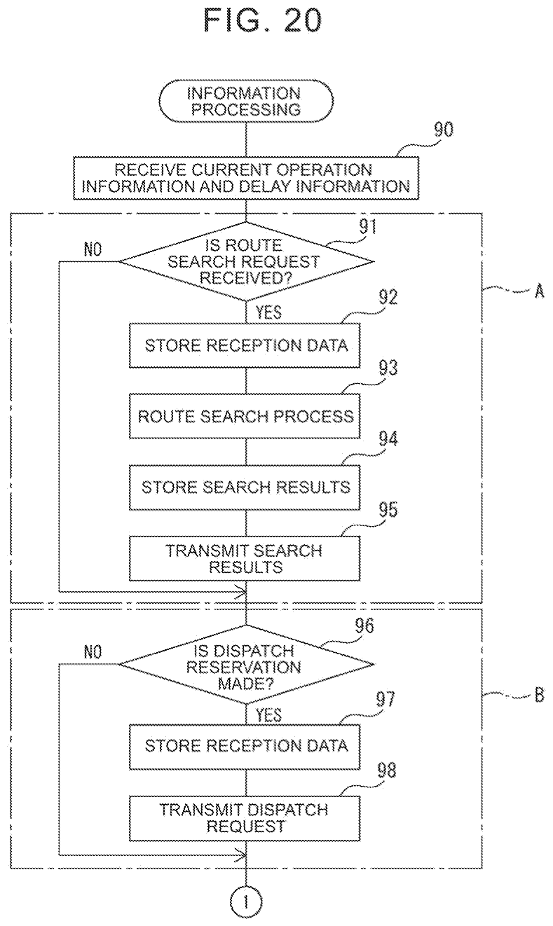

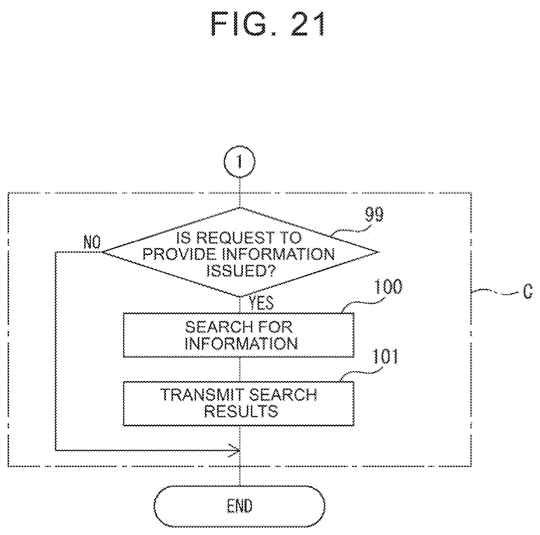

FIGS. 20 and 21 show an information processing routine to be executed by the electronic control unit 10 of the information processing server 3. This routine is repeatedly executed.

Referring to FIGS. 20 and 21, current railroad operation information and current railroad delay information are first received from a railroad operator in step 90. The received current railroad operation information and the received current railroad delay information are stored in the memory 13 of the electronic control unit 10. In part A from step 91 to step 95, the process from (2) to (4) of FIG. 6 is performed.

That is, in step 91, determination is made as to whether a movement route search request is received from the terminal 6. When determination is made that the movement route search request is received from the terminal 6, the routine proceeds to step 92, and reception data including the user's departure point, departure time, destination, and desired arrival time at the destination and received together with the movement route search request is stored in the memory 13 of the electronic control unit 10. In step 93, a search is made for a plurality of movement routes that satisfies the user's request. In step 94, results of the movement route search are stored in the memory 13 of the electronic control unit 10. In step 95, the results of the movement route search are transmitted to the terminal 6. Then, the routine proceeds to step 96. When determination is made in step 91 that the movement route search request is not received from the terminal 6, the routine jumps to step 96.

In part B from step 96 to step 98, the process in (8) of FIG. 6 is performed. In step 96, determination is made as to whether information indicating that a dispatch reservation has been made is received from the terminal 6 together with a desired pick-up position, a desired pick-up time, and a desired drop-off position for the autonomous driving taxi 5 and a user's desired movement route. When determination is made that the information indicating that the dispatch reservation has been made is received from the terminal 6, the routine proceeds to step 97, and the received desired pick-up position, the received desired pick-up time, the received desired drop-off position, and the received user's desired movement route are stored in the memory 13 of the electronic control unit 10. In step 98, a dispatch request including the user's desired movement route, information on a train expected for transfer on the user's desired movement route, the desired pick-up position, the desired pick-up time, and the desired drop-off position for the autonomous driving taxi 5, and a user ID for identifying the user is transmitted to the dispatch management server 4. Then, the routine proceeds to step 99. When determination is made in step 96 that the information indicating that the dispatch reservation has been made is not received from the terminal 6, the routine jumps to step 99.

In part C from step 99 to step 101, the process in (19) of FIG. 6 is performed. In step 99, determination is made as to whether a request to provide traffic information such as traffic congestion on the travel route D of the autonomous driving taxi 5 is issued from the autonomous driving taxi 5. When determination is made that the request to provide traffic information such as traffic congestion is issued, the routine proceeds to step 100. A search is made for traffic information such as traffic congestion on the travel route D of the autonomous driving taxi 5. Next, the routine proceeds to step 101. Search results on traffic information such as traffic congestion on the travel route D of the autonomous driving taxi 5 are transmitted to the autonomous driving taxi 5. Then, the processing cycle is terminated. When determination is made in step 99 that the request to provide traffic information such as traffic congestion is not issued, the processing cycle is terminated.

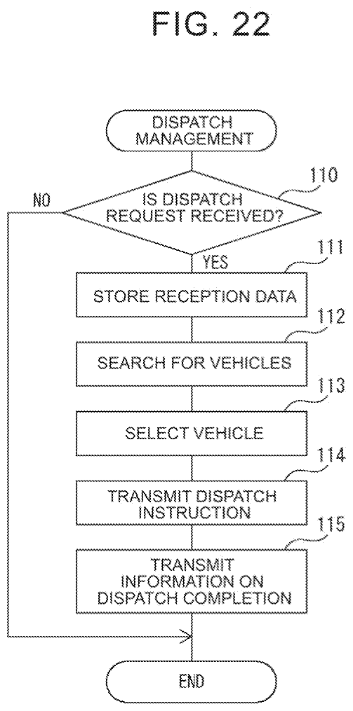

FIG. 22 shows a dispatch management routine for executing the process from (9) to (11) of FIG. 6. The dispatch management routine is repeatedly executed by the electronic control unit 15 of the dispatch management server 4.

Referring to FIG. 22, determination is first made in step 110 as to whether a dispatch request is received from the information processing server 3. When determination is made that the dispatch request is not received from the information processing server 3, the processing cycle is terminated. When determination is made that the dispatch request is received from the information processing server 3, the routine proceeds to step 111, and reception data including a user's desired movement route, information on a train expected for transfer on the user's desired movement route, a desired pick-up position, a desired pick-up time, and a desired drop-off position for the autonomous driving taxi 5, and a user ID is stored in the memory 18 of the electronic control unit 15.

In step 112, a search is made for autonomous driving taxis 5 that can be dispatched to the user's desired pick-up position at the user's desired pick-up time from among the autonomous driving taxis 5 located near the user's desired pick-up position. In this case, the search may be made for currently available autonomous driving taxis 5, and autonomous driving taxis 5 scheduled to become available around the user's desired pick-up time based on reservation information. In step 113, an autonomous driving taxi 5 to be dispatched is selected from among the autonomous driving taxis 5 in the search results. When the autonomous driving taxi 5 to be dispatched is selected, a dispatch instruction is transmitted from the dispatch management server 4 to the autonomous driving taxi 5 selected for dispatch in step 114 together with the user's desired movement route, the information on the train expected for transfer on the user's desired movement route, the desired dispatch details including the pick-up position, the drop-off position, and the pick-up time for the autonomous driving taxi 5, and the user ID. In step 115, information indicating that the dispatch has been completed is transmitted to the terminal 6.

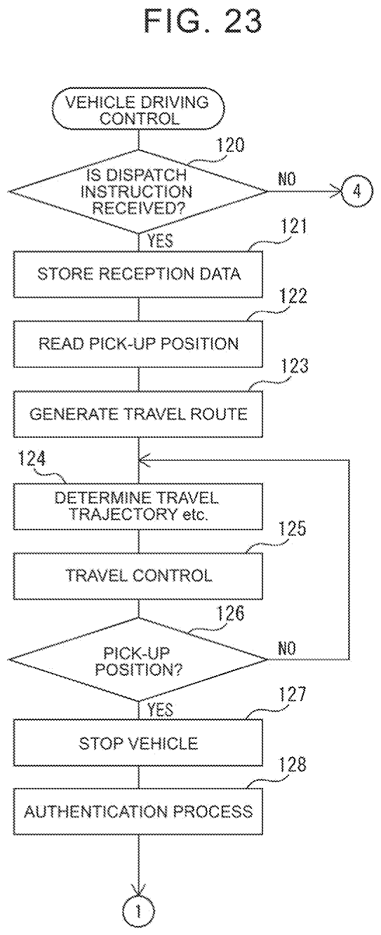

FIGS. 23 to 25 show an autonomous driving taxi driving control routine for executing the process from (12) to (21) of FIG. 6. This routine is repeatedly executed by the electronic control unit 23 of the autonomous driving taxi 5 selected for dispatch.

Referring to FIGS. 23 to 25, determination is first made in step 120 as to whether a dispatch instruction is received from the dispatch management server 4. When determination is made that the dispatch instruction is not received from the dispatch management server 4, the processing cycle is terminated. When determination is made that the dispatch instruction is received from the dispatch management server 4, the routine proceeds to step 121, and reception data including a user's desired movement route, information on a train expected for transfer on the user's desired movement route, a desired pick-up position, a desired pick-up time, and a desired drop-off position for the autonomous driving taxi 5, and a user ID is stored in the memory 26 of the electronic control unit 23.

In step 122, the user's desired pick-up position is read from the memory 26. In step 123, the navigation device 31 generates a travel route of the autonomous driving taxi 5 from the current position to the user's desired pick-up position based on the current position of the autonomous driving taxi 5 acquired by the GNSS receiver 29 and the user's desired pick-up position read from the memory 26. In step 124, a travel trajectory and a travel speed of the autonomous driving taxi 5 on and at which it does not come into contact with other vehicles or pedestrians are determined based on detection results from the sensors such as the cameras that capture a forward image etc. from the autonomous driving taxi 5, the LIDAR sensor, and the radar. In step 125, travel control on the autonomous driving taxi 5 is performed based on the determined travel trajectory and the determined travel speed.

In step 126, determination is made as to whether the autonomous driving taxi 5 has arrived at the user's desired pick-up position. When determination is made that the autonomous driving taxi 5 has not arrived at the user's desired pick-up position, the routine returns to step 124, and the autonomous driving of the autonomous driving taxi 5 is continued. When determination is made in step 126 that the autonomous driving taxi 5 has arrived at the user's desired pick-up position, the routine proceeds to step 127, and the autonomous driving taxi 5 is stopped. In step 128, the user authentication process is performed by short-range communication between the terminal 6 of the user who has made a dispatch reservation and the autonomous driving taxi 5. The authentication process is performed, for example, by checking the user ID stored in the memory 26 of the autonomous driving taxi 5 in response to the dispatch request against the user ID stored in the terminal 6 of the user who has made the dispatch request. When the user IDs agree with each other, the user who carries the terminal 6 is authenticated as the user who has made the dispatch request. Various authentication processes such as face authentication are known as user authentication processes. These known authentication processes can be used as the authentication process in step 128.

In step 129, determination is made as to whether the user who carries the terminal 6 is authenticated as the user who has made the dispatch request in the authentication possess in step 128. When the user who carries the terminal 6 is not authenticated as the user who has made the dispatch request in the authentication possess, the routine jumps to step 146, and the dispatch management server 4 is requested for an instruction on the next action. At this time, the autonomous driving taxi 5 is moved by autonomous driving, for example, toward a desired pick-up position of another user who has made a dispatch request. When the user who carries the terminal 6 is authenticated as the user who has made the dispatch request in the authentication possess, the routine proceeds to step 130, and the door of the autonomous driving taxi 5 is opened. When the door of the autonomous driving taxi 5 is opened, the user who has made the dispatch request gets into the autonomous driving taxi 5 alone, or some people including the user who has made the dispatch request get into the autonomous driving taxi 5.

In step 131, a pick-up check process is performed to check whether the user who has made the dispatch request or some people including the user who has made the dispatch request has/have got into the autonomous driving taxi 5. The pick-up check process is performed by the pick-up check device disposed in the autonomous driving taxi 5, for example, by analyzing an image captured by a pick-up check camera that captures an image of the vehicle cabin. In step 132, determination is made as to whether the user who has made the dispatch request or some people including the user who has made the dispatch request has/have got into the autonomous driving taxi 5. When determination is made that the user or some people including the user has/have not got into the autonomous driving taxi 5, the routine returns to step 131, and the pick-up check process is continued to check whether the user or some people including the user has/have got into the autonomous driving taxi 5. When determination is made in step 132 that the user or some people including the user has/have got into the autonomous driving taxi 5, the routine proceeds to step 133.

In step 133, the door of the autonomous driving taxi 5 is closed. When the door of the autonomous driving taxi 5 is closed, the routine proceeds to step 134, and a travel start request for the autonomous driving taxi 5 is made. The travel start request for the autonomous driving taxi 5 is made, for example, when the user who has got into the taxi touches a travel start button displayed on the display screen 57 of the display device 32 in the autonomous driving taxi 5. When the travel start request for the autonomous driving taxi 5 is made, the routine proceeds to step 135, and the user's desired drop-off position is read from the memory 26. In step 136, the navigation device 31 generates a travel route D of the autonomous driving taxi 5 from the current position to the user's desired drop-off position based on the current position of the autonomous driving taxi 5 acquired by the GNSS receiver 29 and the user's desired drop-off position read from the memory 26.

When the travel route D of the autonomous driving taxi 5 is generated, the routine proceeds to step 137, and the display process in (18) of FIG. 6 is started. In the first embodiment, the display process routine shown in FIG. 14 and the drop-off position change request routine shown in FIG. 17 are started. In step 138, a travel trajectory and a travel speed of the autonomous driving taxi 5 on and at which it does not come into contact with other vehicles or pedestrians are determined based on detection results from the sensors such as the cameras that capture a forward image etc. from the autonomous driving taxi 5, the LIDAR sensor, and the radar. In step 139, travel control on the autonomous driving taxi 5 is performed based on the determined travel trajectory and the determined travel speed.

In step 140, determination is made as to whether a drop-off position change request is issued in the drop-off position change request routine shown in FIG. 17. When determination is made that the drop-off position change request is not issued, the routine proceeds to step 143. When determination is made that the drop-off position change request is issued, the routine proceeds to step 141. In step 141, a new desired drop-off position set by the user is set as the drop-off position. In step 142, the drop-off position is adjusted to the outside of the predetermined range F1, F2 (FIG. 13) from an intersection on the congested travel route D of the autonomous driving taxi 5 when determination is made that the traffic lights E1, E2 (FIG. 13) in the traveling direction of the autonomous driving taxi are green at the intersection based on the traffic information such as traffic congestion and traffic light information detected by sensors such as the cameras that capture a forward image etc. from the autonomous driving taxi 5 or traffic light information transmitted from the traffic lights. Then, the routine proceeds to step 143.

In step 143, determination is made as to whether the autonomous driving taxi 5 has arrived at the drop-off position. This drop-off position is the desired drop-off position at the time of the dispatch reservation made by the user when the drop-off position change request is not issued, and is the new desired drop-off position set by the user when the drop-off position change request is issued. Therefore, the user can drop off the autonomous driving taxi 5 midway before the autonomous driving taxi 5 arrives at the desired drop-off position at the time of the dispatch reservation made by the user.

When determination is made in step 143 that the autonomous driving taxi 5 has not arrived at the drop-off position, the routine returns to step 138, and the autonomous driving of the autonomous driving taxi 5 is continued. When determination is made in step 143 that the autonomous driving taxi 5 has arrived at the drop-off position, the routine proceeds to step 144, and the autonomous driving taxi 5 is stopped. In step 145, a drop-off check process is performed to check whether the user riding in the autonomous driving taxi 5 or some people including the user has/have got out of the autonomous driving taxi 5. The drop-off check process is performed by a drop-off check device disposed in the autonomous driving taxi 5, for example, by analyzing an image captured by a drop-off check camera that captures an image of the vehicle cabin. In step 146, the dispatch management server 4 is requested for an instruction on the next action.

As described above, in the first embodiment, a predetermined travel route range from a point behind the desired drop-off position K of the user of the autonomous driving taxi 5 to the desired drop-off position K on the travel route D of the autonomous driving taxi 5 headed for the desired drop-off position K is set as the permissible midway drop-off range X1 in which midway drop-off from the autonomous driving taxi 5 is permitted. A setting made by the user in the autonomous driving taxi 5 headed for the desired drop-off position K is received about the midway drop-off position P, Q in the permissible midway drop-off range X1. The autonomous driving taxi 5 is stopped at the midway drop-off position P, Q set by the user to allow the user to drop off the autonomous driving taxi 5 midway.

Thus, in the first embodiment, the vehicle control device includes, as shown in the functional configuration diagram of FIG. 5, the range setting unit 46 configured to set a predetermined travel route range from a point behind the desired drop-off position K of the user of the autonomous driving taxi 5 to the desired drop-off position K on the travel route D of the autonomous driving taxi 5 headed for the desired drop-off position K as the permissible midway drop-off range X1 in which midway drop-off from the autonomous driving taxi 5 is permitted, the setting receiving unit 47 configured to receive a setting made by the user in the autonomous driving taxi 5 headed for the desired drop-off position K about the midway drop-off position P, Q in the permissible midway drop-off range X1, and the autonomous driving control unit 42 configured to stop the autonomous driving taxi 5 at the midway drop-off position P, Q set by the user to allow the user to drop off the autonomous driving taxi 5 midway.

Next, each embodiment will be described in sequence. In each embodiment to be described below, the midway drop-off position settable range X2 in which the setting of the midway drop-off position Q in the permissible midway drop-off range X1 can be received in advance is set in addition to the permissible midway drop-off range X1. That is, in each embodiment to be described below, a predetermined travel route range from a point behind the permissible midway drop-off range X1 to the permissible midway drop-off range X1 is set as the midway drop-off position settable range X2 in which the setting of the midway drop-off position in the permissible midway drop-off range X1 is received in advance. When the autonomous driving taxi 5 is located outside the permissible midway drop-off range X1 and the midway drop-off position settable range X2, the reception of the setting of the midway drop-off position in the permissible midway drop-off range X1 is rejected.

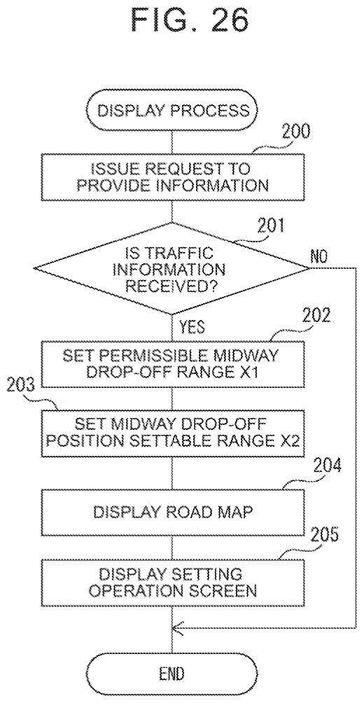

FIGS. 26 to 29 show a second embodiment configured as follows. Immediately when the autonomous driving taxi 5 starts traveling toward the desired drop-off position K of the user of the autonomous driving taxi 5, a map screen and a setting operation screen as shown in FIG. 11 are displayed on the display screen 57 disposed in the vehicle cabin. When the autonomous driving taxi 5 is located outside the permissible midway drop-off range X1 and the midway drop-off position settable range X2 with the map screen and the setting operation screen displayed, the reception of the setting of the midway drop-off position in the permissible midway drop-off range X1 is rejected.

FIG. 26 shows a display process routine for executing the display process in (18) in the flow of FIG. 6. This display process routine is executed by interruption at predetermined time intervals in the electronic control unit 23 of the autonomous driving taxi 5 selected for dispatch.

Referring to FIG. 26, a request to provide traffic information such as traffic congestion is first issued to the information processing server 3 in step 200. In step 201, determination is made as to whether the traffic information such as traffic congestion is received from the information processing server 3 in response to the request. When determination is made that the traffic information such as traffic congestion is not received, the processing cycle is terminated. When determination is made that the traffic information such as traffic congestion is received, the routine proceeds to step 202.

In step 202, a permissible midway drop-off range X1 is set depending on the intensity of traffic congestion. In this case, the permissible midway drop-off range X1 increases as the traffic congestion is heavier as described above. In step 203, a midway drop-off position settable range X2 is set based on the set permissible midway drop-off range X1. In step 204, a road map as shown in FIG. 11 is displayed on the display screen 57 disposed in the vehicle cabin. In step 205, an operation button 60 as shown in FIG. 11 is displayed on the display screen 57 disposed in the vehicle cabin. Then, the processing cycle is terminated. As described above, in the second embodiment, when the autonomous driving taxi 5 starts traveling toward the desired drop-off position K of the user of the autonomous driving taxi 5, the road map and the operation button 60 are displayed on the display screen 57 disposed in the vehicle cabin.

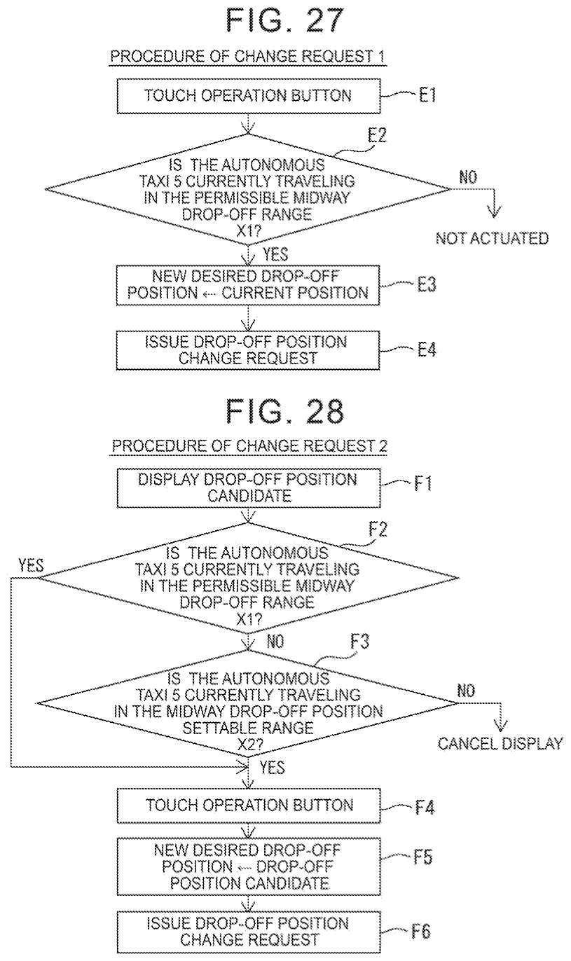

The procedure of a change request 1 shown in FIG. 27 is a procedure for issuing, when the current position of the autonomous driving taxi 5 is the position P as shown in FIG. 11, a drop-off position change request to set the current position P as a new desired drop-off position. Referring to FIG. 27, when the passenger wants to drop off at the current position P, the passenger first touches the operation button 60 on the display screen 57 in E1. When the autonomous driving taxi 5 is traveling in the permissible midway drop-off range X1, as can be seen from E2, the current position P is set as a new desired drop-off position in E3 and then a drop-off position change request is issued in E4. When the autonomous driving taxi 5 is not traveling in the permissible midway drop-off range X1 with the operation button 60 touched by the passenger, the operation button 60 is not actuated as can be seen from E2. That is, there is no reaction even when the operation button 60 is touched by the passenger. Therefore, the drop-off position change request cannot be issued when the autonomous driving taxi 5 is not traveling in the permissible midway drop-off range X1.

The procedure of a change request 2 shown in FIG. 28 is a procedure for issuing, when the passenger displays a drop-off position candidate Q where the passenger wants to drop off on the travel route D ahead of the current position P in the traveling direction as shown in FIG. 12, a drop-off position change request to set the drop-off position candidate Q as a new desired drop-off position. Referring to FIG. 28, when the passenger wants to drop off at the drop-off position candidate Q, the passenger first touches, for example, the travel route D ahead of the current position P in the traveling direction on the display screen 57 with his/her fingertip to display the drop-off position candidate Q at the point touched by the fingertip in F1. When the autonomous driving taxi 5 is traveling in the permissible midway drop-off range X1 or the midway drop-off position settable range X2 in F2 and F3, the passenger touches the operation button 60 on the display screen 57 in F4. In F5, the drop-off position candidate Q is set to a new desired drop-off position. In F6, a drop-off position change request is issued.

When the drop-off position candidate Q is displayed in F1 and the autonomous driving taxi 5 is traveling in neither the permissible midway drop-off range X1 nor the midway drop-off position settable range X2 in F2 and F3, the display of the drop-off position candidate Q is canceled. That is, even when the passenger touches the travel route D ahead of the current position P in the traveling direction on the display screen 57 with his/her fingertip, the drop-off position candidate Q cannot be displayed at the point touched by the fingertip. Therefore, the drop-off position change request cannot be issued when the autonomous driving taxi 5 is traveling in neither the permissible midway drop-off range X1 nor the midway drop-off position settable range X2.

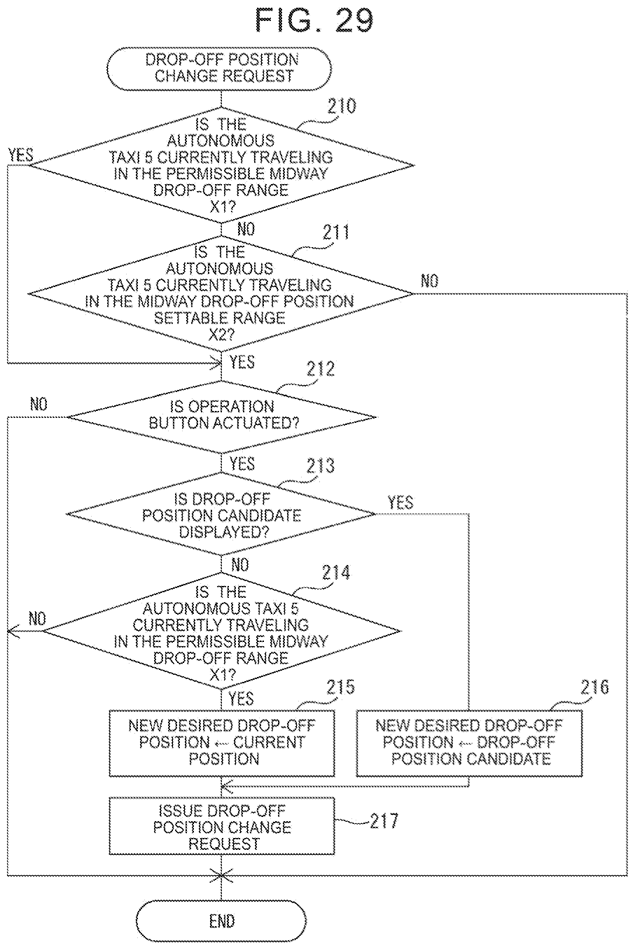

FIG. 29 shows a drop-off position change request routine for executing the procedure of the change request 1 shown in FIG. 27 and the procedure of the change request 2 shown in FIG. 28. This drop-off position change request routine shown in FIG. 29 is executed by interruption at predetermined time intervals in the electronic control unit 23 of the autonomous driving taxi 5. Referring to FIG. 29, determination is first made in step 210 as to whether the autonomous driving taxi 5 is located within the permissible midway drop-off range X1. When determination is made that the autonomous driving taxi 5 is located within the permissible midway drop-off range X1, the routine jumps to step 212. When determination is made that the autonomous driving taxi 5 is not located within the permissible midway drop-off range X1, the routine proceeds to step 211. Determination is made as to whether the autonomous driving taxi 5 is located within the midway drop-off position settable range X2. When determination is made that the autonomous driving taxi 5 is located within the midway drop-off position settable range X2, the routine proceeds to step 212. When determination is made that the autonomous driving taxi 5 is not located within the midway drop-off position settable range X2, the processing cycle is terminated.

In step 212, determination is made as to whether the operation button 60 is actuated, for example, whether the operation button 60 is touched. When determination is made that the operation button 60 is not actuated, the processing cycle is terminated. When determination is made that the operation button 60 is actuated, the routine proceeds to step 213. Determination is made as to whether the drop-off position candidate Q is displayed on the display screen 57 disposed in the vehicle cabin. When determination is made that the drop-off position candidate Q is not displayed on the display screen 57, the routine proceeds to step 214. Determination is made as to whether the autonomous driving taxi 5 is located within the permissible midway drop-off range X1. When determination is made that the autonomous driving taxi 5 is not located within the permissible midway drop-off range X1, the processing cycle is terminated.

When determination is made in step 214 that the autonomous driving taxi 5 is located within the permissible midway drop-off range X1, the routine proceeds to step 215. The current position P is set as a new desired drop-off position. Next, the routine proceeds to step 217, and a drop-off position change request is issued. When determination is made in step 213 that the drop-off position candidate Q is displayed on the display screen 57, the routine proceeds to step 216. The drop-off position candidate Q is set as a new desired drop-off position. Next, the routine proceeds to step 217, and a drop-off position change request is issued.

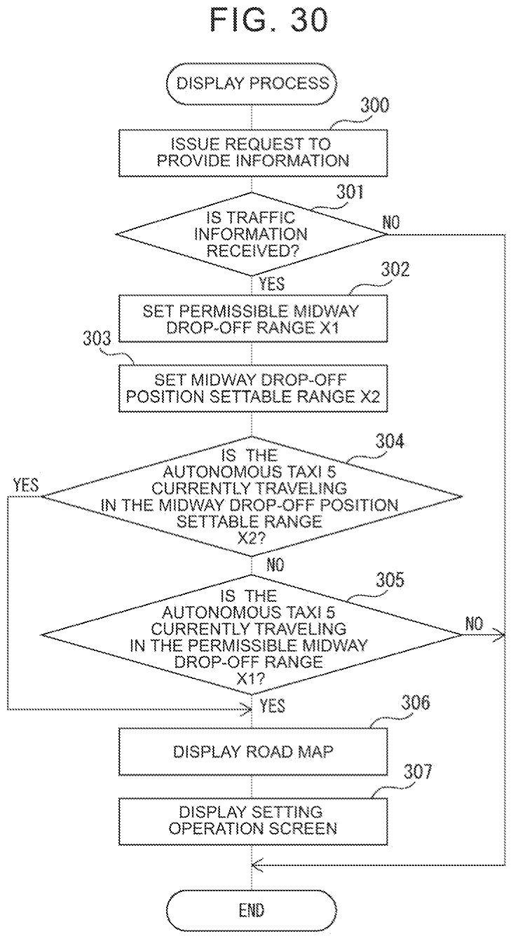

FIG. 30 shows a third embodiment configured as follows. When the autonomous driving taxi 5 is traveling toward the desired drop-off position K of the user of the autonomous driving taxi 5 and enters the midway drop-off position settable range X2, the road map and the operation button 60 are displayed on the display screen 57 disposed in the vehicle cabin. FIG. 30 shows a display process routine in the third embodiment for executing the display process in (18) in the flow of FIG. 6. This display process routine is executed by interruption at predetermined time intervals in the electronic control unit 23 of the autonomous driving taxi 5 selected for dispatch. In the third embodiment, the drop-off position change request routine shown in FIG. 29 is used as a routine for the drop-off position change request.

Referring to FIG. 30, a request to provide traffic information such as traffic congestion is first issued to the information processing server 3 in step 300. In step 301, determination is made as to whether the traffic information such as traffic congestion is received from the information processing server 3 in response to the request. When determination is made that the traffic information such as traffic congestion is not received, the processing cycle is terminated. When determination is made that the traffic information such as traffic congestion is received, the routine proceeds to step 302. In step 302, a permissible midway drop-off range X1 is set depending on the intensity of traffic congestion. In step 303, a midway drop-off position settable range X2 is set based on the set permissible midway drop-off range X1.

In step 304, determination is made as to whether the autonomous driving taxi 5 is located within the midway drop-off position settable range X2. When determination is made that the autonomous driving taxi 5 is located within the midway drop-off position settable range X2, the routine jumps to step 306. When determination is made that the autonomous driving taxi 5 is not located within the midway drop-off position settable range X2, the routine proceeds to step 305. Determination is made as to whether the autonomous driving taxi 5 is located within the permissible midway drop-off range X1. When determination is made that the autonomous driving taxi 5 is located within the permissible midway drop-off range X1, the routine proceeds to step 306. When determination is made that the autonomous driving taxi 5 is not located within the permissible midway drop-off range X1, the processing cycle is terminated. In step 306, a road map as shown in FIG. 11 is displayed on the display screen 57 disposed in the vehicle cabin. In step 307, an operation button 60 as shown in FIG. 11 is displayed on the display screen 57 disposed in the vehicle cabin. Then, the processing cycle is terminated.

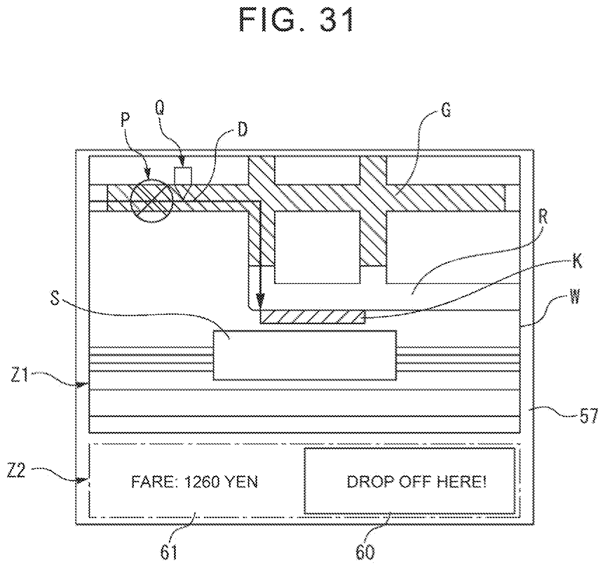

FIGS. 31 to 33 show a fourth embodiment configured as follows. When the drop-off position candidate Q is not displayed on the display screen 57, various types of related information at the current position P, for example, at least one piece of related information 61 among a walking distance and a walking period required in the case of midway drop-off, a period required by the car, a period required until a departure time of a scheduled vehicle to ride next, and a taxi fare are/is displayed in the setting operation screen area Z2 to adjoin the operation button 60 as shown in FIG. 31. When the drop-off position candidate Q is displayed on the display screen 57, various types of related information at the drop-off position candidate Q, for example, at least one piece of related information 61 among a walking distance and a walking period required in the case of midway drop-off, a period required by the car, a period required until a departure time of a scheduled vehicle to ride next, and a taxi fare are/is displayed in the setting operation screen area Z2 to adjoin the operation button 60 as shown in FIG. 31.

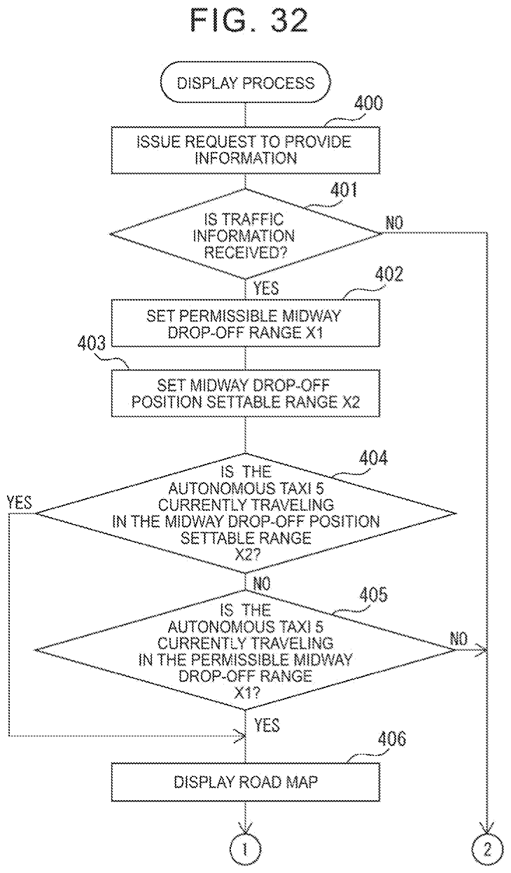

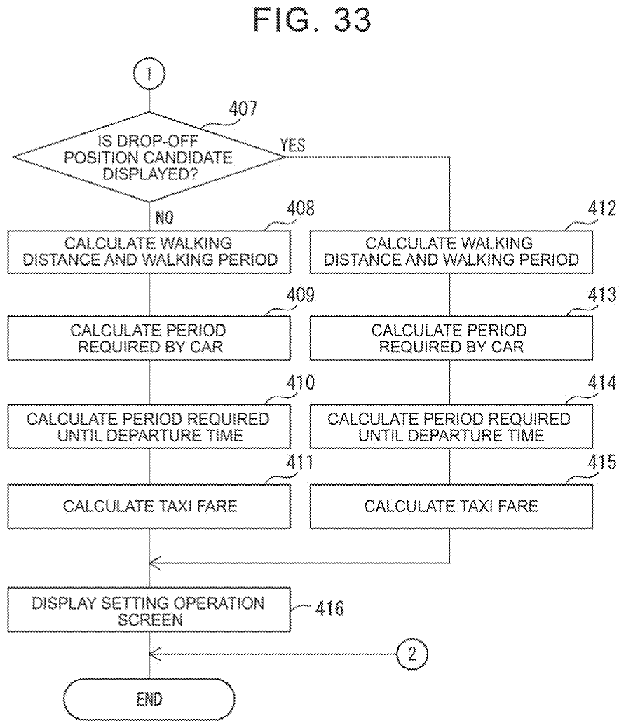

FIGS. 32 and 33 show a display process routine in the fourth embodiment for executing the display process in (18) in the flow of FIG. 6. This display process routine is executed by interruption at predetermined time intervals in the electronic control unit 23 of the autonomous driving taxi 5 selected for dispatch. In the fourth embodiment, the drop-off position change request routine shown in FIG. 29 is used as a routine for the drop-off position change request.

Referring to FIGS. 32 and 33, a request to provide traffic information such as traffic congestion is first issued to the information processing server 3 in step 400. In step 401, determination is made as to whether the traffic information such as traffic congestion is received from the information processing server 3 in response to the request. When determination is made that the traffic information such as traffic congestion is not received, the processing cycle is terminated. When determination is made that the traffic information such as traffic congestion is received, the routine proceeds to step 402. In step 402, a permissible midway drop-off range X1 is set depending on the intensity of traffic congestion. In step 403, a midway drop-off position settable range X2 is set based on the set permissible midway drop-off range X1.

In step 404, determination is made as to whether the autonomous driving taxi 5 is located within the midway drop-off position settable range X2. When determination is made that the autonomous driving taxi 5 is located within the midway drop-off position settable range X2, the routine jumps to step 406. When determination is made that the autonomous driving taxi 5 is not located within the midway drop-off position settable range X2, the routine proceeds to step 405. Determination is made as to whether the autonomous driving taxi 5 is located within the permissible midway drop-off range X1. When determination is made that the autonomous driving taxi 5 is located within the permissible midway drop-off range X1, the routine proceeds to step 406. When determination is made that the autonomous driving taxi 5 is not located within the permissible midway drop-off range X1, the processing cycle is terminated.

In step 406, a road map as shown in FIG. 11 is displayed on the display screen 57 disposed in the vehicle cabin. In step 407, determination is made as to whether the drop-off position candidate Q is displayed on the display screen 57 disposed in the vehicle cabin. When determination is made that the drop-off position candidate Q is not displayed, various types of related information at the current position P of the autonomous driving taxi 5 are obtained in steps 408 to 411.

In step 408, a walking distance and a walking period from the current position P to the user's desired drop-off position K are calculated based on the road map displayed on the display screen 57. In step 409, a period required by the autonomous driving taxi 5 from the current position P to the user's desired drop-off position K is calculated based on the road map displayed on the display screen 57. In step 410, a period required until a departure time of a train expected for transfer is calculated based on a current time and the departure time of the train expected for transfer. In step 411, a taxi fare required in the case of midway drop-off at the current position P is calculated based on a fare calculation system of the autonomous driving taxi 5.

In step 416, at least one piece of related information 61 among the walking distance and the walking period, the period required by the car, the period required until the departure time of the scheduled vehicle to ride next, and the taxi fare that are calculated in steps 408 to 411 is displayed on the display screen 57. In the example shown in FIG. 31, the taxi fare is displayed on the display screen 57.

When determination is made in step 407 that the drop-off position candidate Q is displayed on the display screen 57 disposed in the vehicle cabin, various types of related information at the drop-off position candidate Q of the autonomous driving taxi 5 are obtained in steps 412 to 415. In step 412, a walking distance and a walking period from the drop-off position candidate Q to the user's desired drop-off position K are calculated based on the road map displayed on the display screen 57. In step 413, a period required by the autonomous driving taxi 5 from the drop-off position candidate Q to the user's desired drop-off position K is calculated based on the road map displayed on the display screen 57. In step 414, a period required until a departure time of a train expected for transfer is calculated based on a predicted arrival time at the drop-off position candidate Q and the departure time of the train expected for transfer. In step 415, a taxi fare required in the case of midway drop-off at the drop-off position candidate Q is calculated based on the fare calculation system of the autonomous driving taxi 5.

In step 416, at least one piece of related information 61 among the walking distance and the walking period, the period required by the car, the period required until the departure time of the scheduled vehicle to ride next, and the taxi fare that are calculated in steps 412 to 415 is displayed on the display screen 57.

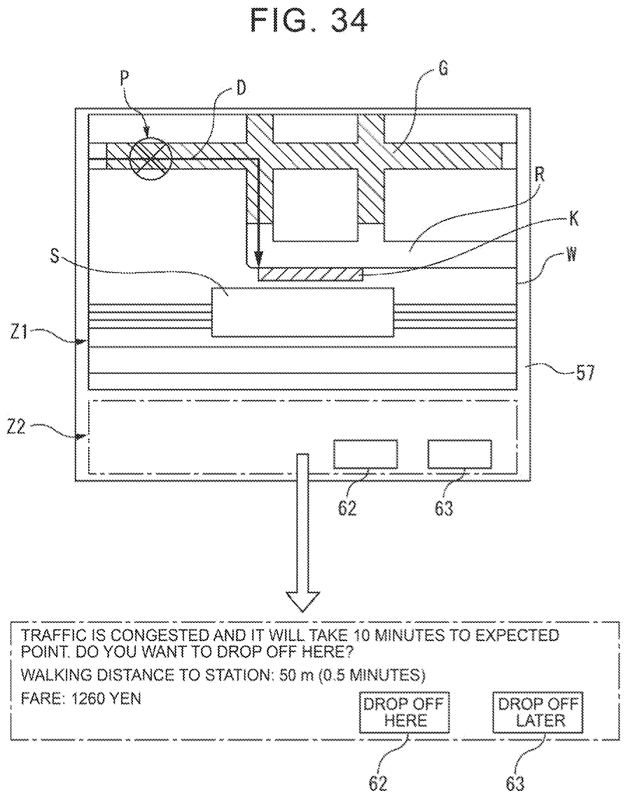

FIGS. 34 to 36 show a fifth embodiment configured as follows. All or part of various types of related information at the current position P, such as a walking distance and a walking period required in the case of midway drop-off, a period required by the car, a period required until a departure time of a scheduled vehicle to ride next, and a taxi fare, are/is displayed in the setting operation screen area Z2 on the display screen 57 disposed in the vehicle cabin as shown in FIG. 34. Further, an operation button 62 with which midway drop-off at the current position P is requested and a reset button 63 with which midway drop-off at the current position P is not requested are displayed. FIG. 34 shows the enlarged setting operation screen area Z2.

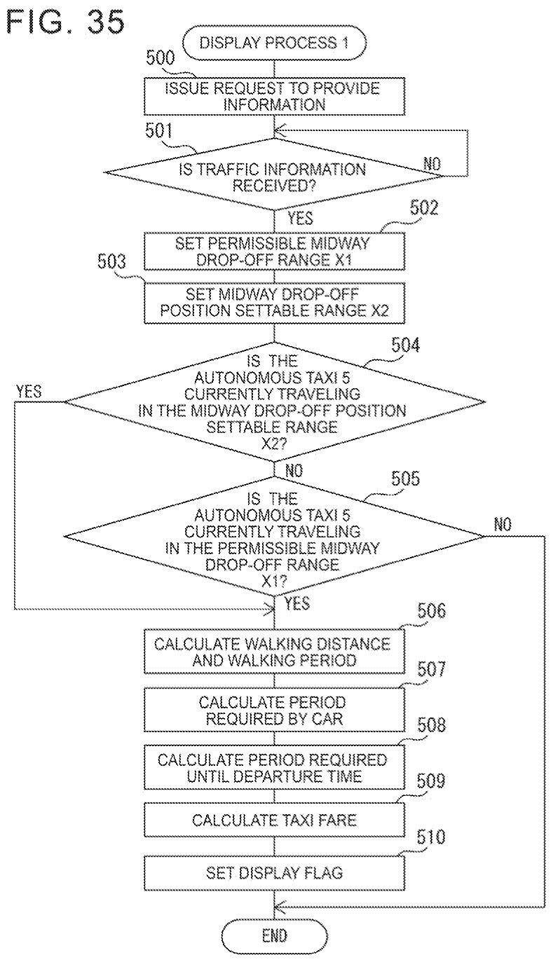

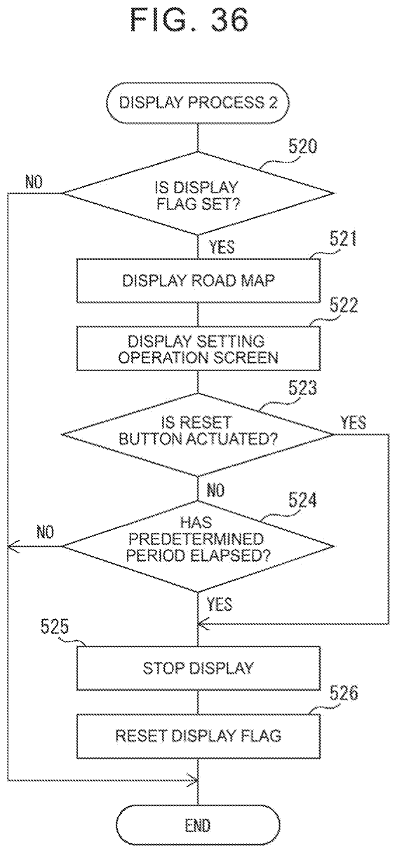

FIGS. 35 and 36 show routines of a display process 1 and a display process 2 in the fifth embodiment for executing the display process in (18) in the flow of FIG. 6. The routine of the display process 1 is executed by interruption at predetermined time intervals of, for example, 3 minutes in the electronic control unit 23 of the autonomous driving taxi 5 selected for dispatch. The routine of the display process 2 is executed by interruption at intervals of, for example, 4 msec in the electronic control unit 23 of the autonomous driving taxi 5 selected for dispatch. In the fifth embodiment, the drop-off position change request routine shown in FIG. 29 is used as a routine for the drop-off position change request.

Referring to FIG. 35, a request to provide traffic information such as traffic congestion is first issued to the information processing server 3 in step 500. In step 501, the electronic control unit 23 waits until the traffic information such as traffic congestion is received from the information processing server 3 in response to the request. When the traffic information such as traffic congestion is received, the routine proceeds to step 502. A permissible midway drop-off range X1 is set depending on the intensity of traffic congestion. In step 503, a midway drop-off position settable range X2 is set based on the set permissible midway drop-off range X1.

In step 504, determination is made as to whether the autonomous driving taxi 5 is located within the midway drop-off position settable range X2. When determination is made that the autonomous driving taxi 5 is located within the midway drop-off position settable range X2, the routine jumps to step 506. When determination is made that the autonomous driving taxi 5 is not located within the midway drop-off position settable range X2, the routine proceeds to step 505. Determination is made as to whether the autonomous driving taxi 5 is located within the permissible midway drop-off range X1. When determination is made that the autonomous driving taxi 5 is located within the permissible midway drop-off range X1, the routine proceeds to step 506. When determination is made that the autonomous driving taxi 5 is not located within the permissible midway drop-off range X1, the processing cycle is terminated.

In steps 506 to 509, various types of related information at the current position P of the autonomous driving taxi 5 are obtained. In step 506, a walking distance and a walking period from the current position P to the user's desired drop-off position K are calculated based on the road map displayed on the display screen 57. In step 507, a period required by the autonomous driving taxi 5 from the current position P to the user's desired drop-off position K is calculated based on the road map displayed on the display screen 57. In step 508, a period required until a departure time of a train expected for transfer is calculated based on a current time and the departure time of the train expected for transfer. In step 509, a taxi fare required in the case of midway drop-off at the current position P is calculated based on the fare calculation system of the autonomous driving taxi 5. In step 510, a display flag is set.

Referring to FIG. 36, determination is first made in step 520 as to whether the display flag is set. When determination is made that the display flag is not set, the processing cycle is terminated. When determination is made that the display flag is set, the routine proceeds to step 521, and a road map as shown in FIG. 34 is displayed on the display screen 57 disposed in the vehicle cabin. In step 522, a message as shown in FIG. 34 including all or part of the walking distance and the walking period, the period required by the car, the period required until the departure time of the scheduled vehicle to ride next, and the taxi fare that are calculated in steps 506 to 509 is displayed in the setting operation screen area Z2 of the display screen 57 together with the operation button 62 and the reset button 63.

In step 523, determination is made as to whether the reset button 63 is actuated. When determination is made that the reset button 63 is actuated, the routine proceeds to step 525. The display of the road map and the setting operation screen area Z2 or only the display of the setting operation screen area Z2 is stopped. In step 526, the display flag is reset. When determination is made that the reset button 63 is not actuated, the routine proceeds to step 524. Determination is made as to whether a predetermined period has elapsed. When determination is made that the predetermined period has elapsed, the routine proceeds to step 525. The display of the road map and the setting operation screen area Z2 or only the display of the setting operation screen area Z2 is stopped. When the operation button 62 is actuated, the current position P is set as a new desired drop-off position and a drop-off position change request is issued in the drop-off position change request routine shown in FIG. 29.

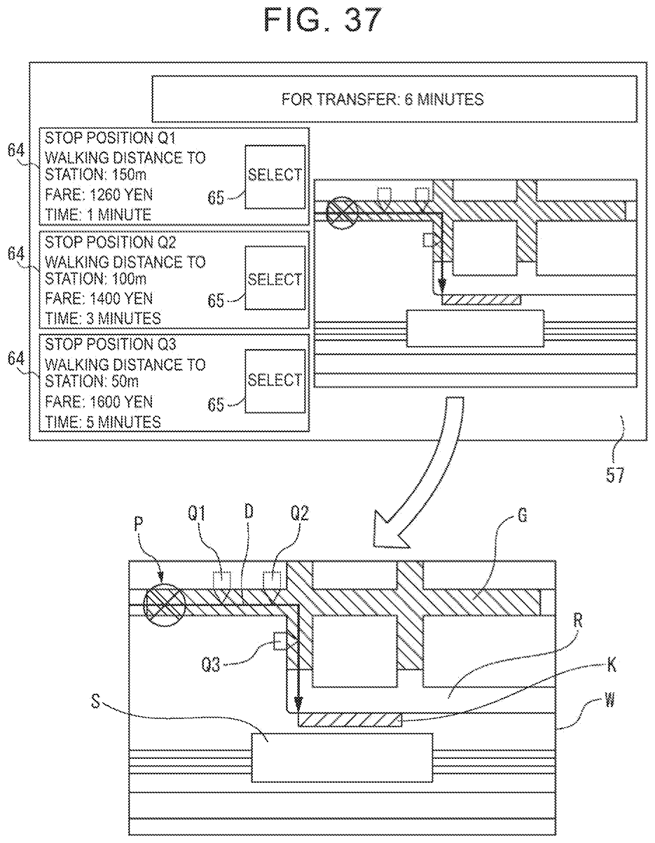

FIGS. 37 to 40 show a sixth embodiment configured as follows. A plurality of drop-off position candidates Q1, Q2, Q3, etc. is displayed on the road map on the display screen 57 disposed in the vehicle cabin, and all or part of various types of related information such as a walking distance and a walking period required in the case of midway drop-off, a period required by the car, a period required until a departure time of a scheduled vehicle to ride next, and a taxi fare, are/is displayed for each of the drop-off position candidates Q1, Q2, Q3, etc. A desired drop-off position candidate Q can be selected from among the drop-off position candidates Q1, Q2, Q3, etc. FIG. 37 shows the enlarged road map.

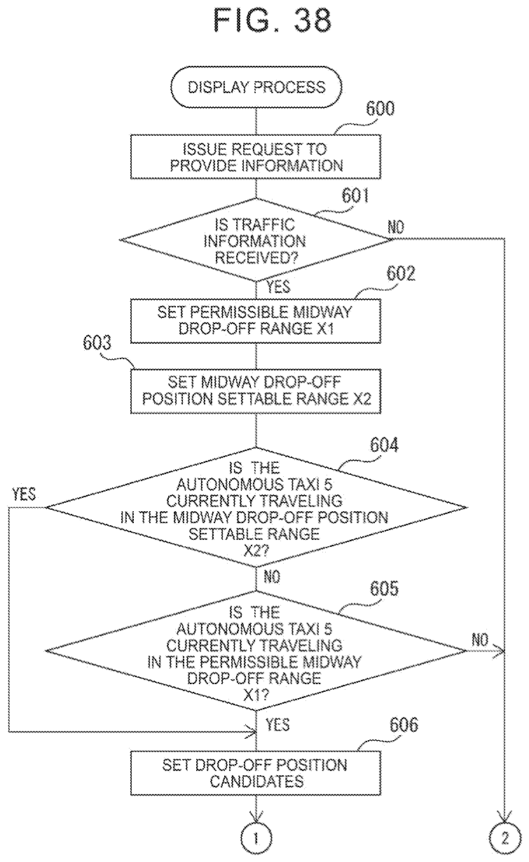

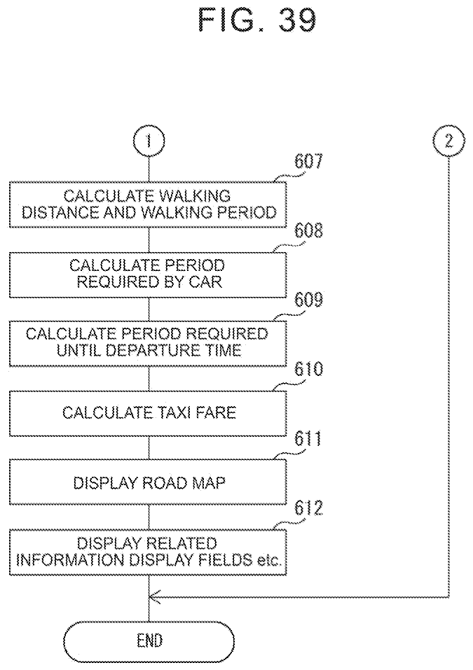

FIGS. 38 and 39 show a display process routine in the sixth embodiment for executing the display process in (18) in the flow of FIG. 6. This display process routine is executed by interruption at predetermined time intervals in the electronic control unit 23 of the autonomous driving taxi 5 selected for dispatch.

Referring to FIGS. 38 and 39, a request to provide traffic information such as traffic congestion is first issued to the information processing server 3 in step 600. In step 601, determination is made as to whether the traffic information such as traffic congestion is received from the information processing server 3 in response to the request. When determination is made that the traffic information such as traffic congestion is not received, the processing cycle is terminated. When determination is made that the traffic information such as traffic congestion is received, the routine proceeds to step 602. In step 602, a permissible midway drop-off range X1 is set depending on the intensity of traffic congestion. In step 603, a midway drop-off position settable range X2 is set based on the set permissible midway drop-off range X1.

In step 604, determination is made as to whether the autonomous driving taxi 5 is located within the midway drop-off position settable range X2. When determination is made that the autonomous driving taxi 5 is located within the midway drop-off position settable range X2, the routine jumps to step 606. When determination is made that the autonomous driving taxi 5 is not located within the midway drop-off position settable range X2, the routine proceeds to step 605. Determination is made as to whether the autonomous driving taxi 5 is located within the permissible midway drop-off range X1. When determination is made that the autonomous driving taxi 5 is located within the permissible midway drop-off range X1, the routine proceeds to step 606. When determination is made that the autonomous driving taxi 5 is not located within the permissible midway drop-off range X1, the processing cycle is terminated.

In step 606, a plurality of drop-off position candidates Q1, Q2, Q3, etc. is set and displayed on the road map on the display screen 57 as shown in FIG. 37. The drop-off position candidates Q1, Q2, Q3, etc. are set, for example, at positions equidistant from each other between the current position P and the user's desired drop-off position K. In steps 607 to 610, various types of related information are obtained for each of the drop-off position candidates Q1, Q2, Q3, etc. In step 607, a walking distance and a walking period from each of the drop-off position candidates Q1, Q2, Q3, etc. to the user's desired drop-off position K are calculated based on the road map displayed on the display screen 57. In step 608, a period required by the car from each of the drop-off position candidates Q1, Q2, Q3, etc. to the user's desired drop-off position K is calculated based on the road map displayed on the display screen 57. In step 609, a period required until a departure time of a train expected for transfer is calculated based on a current time and the departure time of the train expected for transfer. In step 610, a taxi fare required in the case of midway drop-off at each of the drop-off position candidates Q1, Q2, Q3, etc. is calculated based on the fare calculation system of the autonomous driving taxi 5.

In step 611, a road map as shown in FIG. 37 is displayed on the display screen 57. In step 612, a related information display field 64 including all or part of the walking distance and the walking period, the period required by the car, the taxi fare, etc. that are calculated in steps 607 to 610 is displayed on the display screen 57 for each of the drop-off position candidates Q1, Q2, Q3, etc. as shown in FIG. 37. In the related information display fields 64, the drop-off position candidates Q1, Q2, Q3 are displayed as “stop position Q1”, “stop position Q2”, and “stop position Q3”, respectively. A selection button 65 is displayed in each related information display field 64, and the period required until the departure time of the scheduled vehicle to ride next is displayed on the display screen 57.

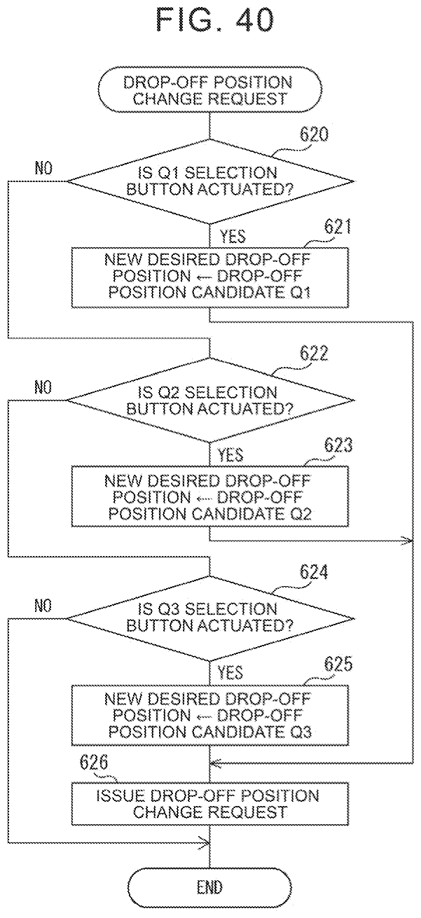

FIG. 40 shows a drop-off position change request routine used in the sixth embodiment. This drop-off position change request routine is executed by interruption at predetermined time intervals in the electronic control unit 23 of the autonomous driving taxi 5. Referring to FIG. 40, determination is first made in step 620 as to whether the selection button 65 for the stop position Q1, that is, the drop-off position candidate Q1 is actuated. When determination is made that the selection button 65 for the drop-off position candidate Q1 is actuated, the routine proceeds to step 621. The drop-off position candidate Q1 is set as a new desired drop-off position. Next, the routine proceeds to step 626, and a drop-off position change request is issued. When determination is made in step 620 that the selection button 65 for the drop-off position candidate Q1 is not actuated, the routine proceeds to step 622.

In step 622, determination is made as to whether the selection button 65 for the stop position Q2, that is, the drop-off position candidate Q2 is actuated. When determination is made that the selection button 65 for the drop-off position candidate Q2 is actuated, the routine proceeds to step 623. The drop-off position candidate Q2 is set as a new desired drop-off position. Next, the routine proceeds to step 626, and a drop-off position change request is issued. When determination is made in step 622 that the selection button 65 for the drop-off position candidate Q2 is not actuated, the routine proceeds to step 624.

In step 624, determination is made as to whether the selection button 65 for the stop position Q3, that is, the drop-off position candidate Q3 is actuated. When determination is made that the selection button 65 for the drop-off position candidate Q3 is actuated, the routine proceeds to step 625. The drop-off position candidate Q3 is set as a new desired drop-off position. Next, the routine proceeds to step 626, and a drop-off position change request is issued. When determination is made in step 624 that the selection button 65 for the drop-off position candidate Q3 is not actuated, the processing cycle is terminated.

As described above, in the embodiments of the present disclosure, the vehicle control device includes the range setting unit 46 configured to set a predetermined travel route range from a point behind the desired drop-off position of the user of the autonomous driving taxi 5 to the desired drop-off position on the travel route D of the autonomous driving taxi 5 headed for the desired drop-off position as the permissible midway drop-off range X1 in which midway drop-off from the autonomous driving taxi 5 is permitted, the setting receiving unit 47 configured to receive a setting made by the user in the autonomous driving taxi 5 headed for the desired drop-off position about the midway drop-off position in the permissible midway drop-off range X1, and the autonomous driving control unit 42 configured to stop the autonomous driving taxi 5 at the midway drop-off position set by the user to allow the user to drop off the autonomous driving taxi 5 midway.

The embodiments of the present disclosure provide a vehicle control method including setting a predetermined travel route range from a point behind the desired drop-off position of the user of the autonomous driving taxi 5 to the desired drop-off position on the travel route D of the autonomous driving taxi 5 headed for the desired drop-off position as the permissible midway drop-off range X1 in which midway drop-off from the autonomous driving taxi 5 is permitted, receiving a setting made by the user in the autonomous driving taxi 5 headed for the desired drop-off position about the midway drop-off position in the permissible midway drop-off range X1, and stopping the autonomous driving taxi 5 at the midway drop-off position set by the user to allow the user to drop off the autonomous driving taxi 5 midway.

The embodiments of the present disclosure provide a program causing a computer to perform functions including setting a predetermined travel route range from a point behind the desired drop-off position of the user of the autonomous driving taxi 5 to the desired drop-off position on the travel route D of the autonomous driving taxi 5 headed for the desired drop-off position as the permissible midway drop-off range X1 in which midway drop-off from the autonomous driving taxi is permitted, receiving a setting made by the user in the autonomous driving taxi 5 headed for the desired drop-off position about the midway drop-off position in the permissible midway drop-off range X1, and stopping the autonomous driving taxi 5 at the midway drop-off position set by the user to allow the user to drop off the autonomous driving taxi 5 midway.

In the embodiments of the present disclosure, the travel route range in which a walk is recommended over the movement by the autonomous driving taxi 5 is set as the permissible midway drop-off range X1. The range setting unit 46 sets a predetermined travel route range from a point behind the permissible midway drop-off range X1 to the permissible midway drop-off range X1 as the midway drop-off position settable range X2 in which the setting receiving unit 47 receives the setting of the midway drop-off position in the permissible midway drop-off range X1 in advance. In this case, the autonomous driving taxi 5 in at least the permissible midway drop-off range X1 performs autonomous driving at a vehicle speed lower than the vehicle speed during normal driving on the travel route D before arrival at the midway drop-off position settable range X2.

In the embodiments of the present disclosure, when the autonomous driving taxi 5 is located outside the permissible midway drop-off range X1 and the midway drop-off position settable range X2, the setting receiving unit 47 rejects the reception of the setting of the midway drop-off position in the permissible midway drop-off range X1. In the embodiments of the present disclosure, when the autonomous driving taxi 5 enters the midway drop-off position settable range X2 along the travel route D, the setting operation screen for the midway drop-off position is displayed on the display screen 57 disposed in the autonomous driving taxi 5. In the embodiments of the present disclosure, the permissible midway drop-off range X1 is set to change depending on the traffic condition.

In the embodiments of the present disclosure, when traffic lights in the traveling direction of the autonomous driving taxi 5 are green at an intersection on the travel route D of the autonomous driving taxi 5, the midway drop-off from the autonomous driving taxi 5 on the travel route D within the predetermined range from the intersection is prohibited though the autonomous driving taxi 5 is in the permissible midway drop-off range X1. The embodiments of the present disclosure provide the display control unit 48 configured to display, on the display screen 57 disposed in the autonomous driving taxi 5, at least one of a walking distance and a walking period, a period required by the car, a period required until a departure time of a scheduled vehicle to ride next, and a taxi fare.

The display control unit 48 displays, on the display screen 57 disposed in the autonomous driving taxi 5, a suggestion to drop off the autonomous driving taxi 5 based on at least the period required by the car. When the autonomous driving taxi 5 is located within the permissible midway drop-off range X1 or the midway drop-off position settable range X2, the display control unit 48 displays a plurality of candidates for the midway drop-off position in the permissible midway drop-off range X1 together with at least one of the walking distance and the walking period, the period required by the car, the period required until the departure time of the scheduled vehicle to ride next, and the taxi fare.

What is claimed is:

1. A vehicle control device comprising one or more processors configured to:
on a travel route of an autonomous driving taxi configured to travel toward a desired drop-off position of a user of the autonomous driving taxi, set a predetermined travel route range from a point behind the desired drop-off position to the desired drop-off position, as a permissible midway drop-off range in which midway drop-off from the autonomous driving taxi is permitted;
receive a setting about a midway drop-off position in the permissible midway drop-off range, the setting being made by the user in the autonomous driving taxi configured to travel toward the desired drop-off position; and
stop the autonomous driving taxi at the midway drop-off position set by the user such that the user drops off the autonomous driving taxi midway.

2. The vehicle control device according to claim 1, wherein the permissible midway drop-off range is a travel route range in which a walk is recommended over movement by the autonomous driving taxi.

3. The vehicle control device according to claim 1, wherein the one or more processors are configured to set a predetermined travel route range from a point behind the permissible midway drop-off range to the permissible midway drop-off range as a midway drop-off position settable range, the midway drop-off position settable range being a range in which the setting of the midway drop-off position in the permissible midway drop-off range is received in advance.

4. The vehicle control device according to claim 3, wherein the autonomous driving taxi is configured to, in at least the permissible midway drop-off range, perform autonomous driving at a vehicle speed lower than a vehicle speed during normal driving on the travel route before arrival at the midway drop-off position settable range.

5. The vehicle control device according to claim 3, wherein the one or more processors are configured to, when the autonomous driving taxi is located outside the permissible midway drop-off range and the midway drop-off position settable range, reject reception of the setting of the midway drop-off position in the permissible midway drop-off range.

6. The vehicle control device according to claim 3, wherein when the autonomous driving taxi enters the midway drop-off position settable range along a travel route from current position to the desired drop-off position, a setting operation screen for the setting of the midway drop-off position is displayed on a display screen disposed in the autonomous driving taxi.

7. The vehicle control device according to claim 1, wherein the permissible midway drop-off range is set to change depending on a traffic condition.

8. The vehicle control device according to claim 1, wherein when traffic lights in a traveling direction of the autonomous driving taxi are green at an intersection on the travel route of the autonomous driving taxi, midway drop-off from the autonomous driving taxi on the travel route within a predetermined range from the intersection is prohibited though the autonomous driving taxi is in the permissible midway drop-off range.

9. The vehicle control device according to claim 1, wherein the one or more processors are configured to display, on a display screen disposed in the autonomous driving taxi, at least one of a walking distance and a walking period, a period required by a car, a period required until a departure time of a scheduled vehicle that the user rides next, and a taxi fare.

10. The vehicle control device according to claim 9, wherein the one or more processors are configured to display, on the display screen disposed in the autonomous driving taxi, a suggestion to drop off the autonomous driving taxi based on at least the period required by the car.

11. The vehicle control device according to claim 9, wherein the one or more processors are configured to, when the autonomous driving taxi is located within the permissible midway drop-off range or a midway drop-off position settable range, display a plurality of candidates for the midway drop-off position in the permissible midway drop-off range together with at least one of the walking distance and the walking period, the period required by the car, the period required until the departure time of the scheduled vehicle to ride next, and the taxi fare, the midway drop-off position settable range being a range in which the setting of the midway drop-off position in the permissible midway drop-off range is received in advance.

12. A vehicle control method comprising:
on a travel route of an autonomous driving taxi configured to travel toward a desired drop-off position of a user of the autonomous driving taxi, setting a predetermined travel route range from a point behind the desired drop-off position to the desired drop-off position, as a permissible midway drop-off range in which midway drop-off from the autonomous driving taxi is permitted;
receiving a setting about a midway drop-off position in the permissible midway drop-off range, the setting being made by the user in the autonomous driving taxi configured to travel toward the desired drop-off position; and
stopping the autonomous driving taxi at the midway drop-off position set by the user such that the user drops off the autonomous driving taxi midway.

13. A non-transitory storage medium storing instructions that are executable by one or more processors and that cause the one or more processors to perform functions comprising:
on a travel route of an autonomous driving taxi configured to travel toward a desired drop-off position of a user of the autonomous driving taxi, setting a predetermined travel route range from a point behind the desired drop-off position, to the desired drop-off position as a permissible midway drop-off range in which midway drop-off from the autonomous driving taxi is permitted;
receiving a setting about a midway drop-off position in the permissible midway drop-off range, the setting being made by the user in the autonomous driving taxi configured to travel toward the desired drop-off position; and
stopping the autonomous driving taxi at the midway drop-off position set by the user such that the user drops off the autonomous driving taxi midway.
